(19) United States
(12) Patent Application Publication
(10) Pub. No.: US 2016/0026729 A1
(43) Pub. Date: Jan. 28, 2016

(54) SYSTEMS AND METHODS INVOLVING MOBILE INDOOR ENERGY EFFICIENCY EXPLORATION, MONITORING AND/OR DISPLAY ASPECTS

(71) Applicant: Reylabs Inc, Campbell, CA (US)

(72) Inventors: Reynaldo GIL, Campbell, CA (US); Gabriel Paunescu, Bucuresti (RO)

(21) Appl. No.: 14/727,816

(22) Filed: Jun. 1, 2015

Related U.S. Application Data
(60) Provisional application No. 62/006,028, filed on May 30, 2014.

(51) Int. Cl. G06F 17/30; H04L 29/08; H04L 29/06

(52) U.S. Cl. CPC G06F 17/30896; H04L 63/1416; G06F 17/30902; H04L 67/02; H04L 67/22

(57) ABSTRACT

Certain systems and methods herein are directed to features of accessing and/or improving building system efficiency, including aspects involving IoT (the Internet of things). For example, some embodiments may include features related to measuring occupant comfort, features related to conserving energy in heating and cooling, improving machine efficiency by increasing maintenance effectiveness, among many others. The safe fusion of sensor data from human devices, machines and space provides a new correlated collection of data for analysis and optimization of building control systems. Innovations herein may pertain, inter alia, to buildings including commercial, homes, industrial and transportation-oriented spaces such as ships, trains, airplanes, and mobile homes.

### CROSS-REFERENCE TO RELATED APPLICATION(S)

This application claims benefit/priority of U.S. provisional patent application No. 62/006,028, filed May 30, 2014, which is incorporated herein by reference in entirety.

### APPENDICES

This application incorporates the attached Appendix of computer code and representative dynamic code routing processes in connection with which certain implementations and/or aspects of the innovations herein may be utilized.

### BACKGROUND

1. Field

This application relates to the field of computerized instrumentation, processing and data collection measurements such as those relating to building space, human comfort and equipment health.

2. Description of Related Information

From now until 2035, two thirds of the economic potential to improve energy efficiency remain untapped, for example, 52% Greenhouse gases produced by end-users; 58% Unrealized energy Efficiency potential Industry; 79% Unrealized energy Efficiency potential Infrastructure; 82% Unrealized energy Efficiency potential Buildings and Data Centre; and 98% Undeserved Small and Medium size buildings less than 100,000 square feet.

Energy Efficiency is the cheapest, fastest, and most reliable way to create jobs, save consumers money and cut pollution from the power sector.” Governor Jerry Brown

One problem may be that 50% of energy improvement costs are customer acquisition and installation for energy improvements including solar, energy storage, HVAC and other equipment. Older ways of addressing the problem known as “React and Scramble” service for old buildings is expensive and causes move-outs, long vacancies. Additionally, discovering/financing energy efficiency projects requires experts, takes too long, costs too much. Existing energy audit and control systems are also limited to measurements generated by stationary sensor-based devices such as thermostats and smoke detectors affecting their ability to adjust settings to the comfort of occupants. Many of these devices require local and wireless networks connecting the sensors with building energy modeling and control systems. These networks are susceptible to intrusion and malware when they are connected to the Internet (cloud) or Internet-connected devices.

### OVERVIEW OF SOME ASPECTS

Systems and methods herein involve aspects of accessing and/or improving building system efficiency. For example, some embodiments may include features related to measuring occupant comfort, features related to conserving energy in heating and cooling, improving machine efficiency by increasing maintenance effectiveness among many others. The safe fusion of sensor data from human devices, machines and space provides a new correlated collection of data for analysis and optimization of building control systems. Innovations herein pertain, inter alia, to buildings including commercial, homes, industrial and transportation-oriented spaces such as ships, trains, airplanes, mobile homes.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 is an example of prior art.

FIG. 2 is an example diagram showing certain implementations of current methods of obtaining building space, human comfort and equipment measurements to detect thermal conditions using infrared cameras and other sensors. FIG. 2 includes a modern sensor-based smartphone platform with similar characteristics as server-based sensor systems—multi-core processing, 64-bit high speed data processing. ReyLabs platform generates sensor-based data collection fusion applications to run autonomously on the smartphone as a micro server platform. Data from multiple sensors are fused together into data collections including video and photographs (machine vision), audio (acoustics), vibration measurements of machinery and can read data from human comfort sensors on the smartphone or external fitness or health monitoring wearable devices. Other sensor-based computer examples include drones, robotics, wearable computers, smart glasses and more. Using the smartphone as a sensor-based platform allows for easier data collection and aggregation tasks without depending on expansive infrastructure investments (networks, PCs, IT support personnel) or placement of fixed sensors (thermostats, etc.).

FIG. 3 is an example chart showing the enhanced value created by energy efficiency to properties. Energy efficient buildings command higher rental or sales prices.

FIG. 4 in one embodiment of the invention the server generates a Big Data playbook containing code and data used to create case collections of sensor data from machines and other sources.

FIG. 5 there are many inherent risks in a costly connected device architecture where hackers have the opportunity to penetrate servers or devices.

FIG. 6 risks are increasing with the proliferation of devices with embedded code lacking proper security maintenance inside private spaces and networks.

FIG. 7 millions of routers were hacked in Brazil due to unsupported embedded code in access routers to homes and businesses.

FIG. 8 cloud-based, server-dependent systems also consume expensive data center resources utilizing carbon-based fuels. A distributed architecture where the main data processing is done on the data collection nodes (portable smartphones and other sensor-based systems) reduces carbon footprints and network connection charges in addition to reducing intrusion risks.

FIG. 9 there are many personal comfort or fitness devices collecting measurements to help optimize human performance. Our system aggregates the human comfort measurements into case collections fusing data from smartphone environmental and machine health sensors to create a unique correlated view of heating and cooling issues. The fused data allows for faster discovery of causes of discomfort—cooling/heating hotspots or machine Mures causing excessive thermal, noise or vibration impacts.

FIG. 10 describes one embodiment of the invention where a small footprint cloud server includes a mix of proprietary and open source code using API to communicate with external servers.

FIG. 11 compares the characteristics of the invention with status quo labor-intensive or IT-intensive systems including current generations of fixed location devices limited by their data collection capabilities.

FIG. 12 invention platform can be used by a wider audience than traditional methods to collect data to be used for machine maintenance or building management.

FIG. 13 one embodiment of the invention packages the system into a big data collection recorder and a big data collection recorder. The BD3 format is a big data collection using JSON objects with ability to share and transform the objects into formats compatible with external systems including building measurement, auditing, compliance and business intelligence (Big Data). The invention employs crowdsensing meaning multiple portable devices can act as energy and environmental metering systems to collect more granular level data than stationary metering devices.

FIG. 14 illustrates the fast value creation using the invention due to reduced capital and expenses associated with energy audits and monitoring and verification.

FIG. 15 represents the value created by improvements to building facilities and machine maintenance leading to improved tenant/resident comfort with the reduction in negative effects such as turnovers or vacancies.

FIG. 16 this table compares various business models including the one enabled by this invention called mobile indoor energy efficiency exploration and monitoring platform. The reduction of dependencies on IT assets and skilled labor required to accomplish facility energy and machine maintenance tasks are contrasted by the business model of invention and status quo business models requiring IT capital, advanced IT and engineering expertise and other expenses.

FIG. 17 represents a data center tenant revenue generation for a real estate company for data center service companies. Tenants spend almost 40% of the costs in energy, cooling and operating costs due to complexity of the operations and inefficient energy consumption by equipment. Most of these costs are reduced by invention by identifying the opportunity to substantively reduce the energy demand on the data center by data-intensive equipment using the lowest cost sensor data collection, fusion, aggregation and transmission costs which do not add to the data center loads.

FIG. 18 is an example of efficiencies obtained using cloud-based systems for a supply chain.

FIG. 19 is another method for integration the server containers with external storage systems represented by Box and a legacy hosted Windows server for a building management system. The common data exchange format is a proprietary data collection based on JSON format data streams.

FIG. 20 in one embodiment of the invention there is a variety of sensor-based devices and sensor-labels fused with data from human wearable devices to provide a complete picture of machine, human and environmental energy consumption and comfort. Other embodiments may include drones, robots or other portable sensor-based devices designed to capture environmental and machine condition data, embedded inside machinery or non-invasively attached to machines or environmental zones where machines are located.

FIG. 21 there is general worldwide trend toward urbanization for different demographic groups.

FIG. 22 there are proven local diagnostic, sensor-based processes employed in many industries including automotive, healthcare and connected Internet o Things (IoT).

FIG. 23 is an example diagram showing certain implementations of features in a smartphone duplicating sensors found in industrial and other areas.

FIG. 24 represents the extent of energy efficiency automation in the global marketplace.

FIG. 25 represents the investment of assets in different classes of infrastructure.

FIG. 26 some energy efficiency companies employ meter data provided by the utility companies. This data does not provide insights into causes of energy consumption in a space or comfort issues.

FIG. 27 represents the causes of carbon emissions from buildings, industry and transport. Biggest factors in buildings are machinery and lighting due to human or machine activities (demand creation).

FIG. 28 in one embodiment of the invention the maintenance process uses our sensor-based data collection methods before tenant move-in, during emergency repairs and after move-out.

FIG. 29 tenant satisfaction is impacted by speed, quality and responsiveness of service operations during a failure or service request situation.

FIG. 30 in one embodiment of the invention demonstrating the environmental sensors being deployed in a smartphone combined with machine vibration and magnetic forces.

FIG. 31 is one embodiment of a Playbook application designed to guide the user through the data collection process including visual identification of devices and selection of diagnostic or maintenance mode.

FIG. 32 is one embodiment of the invention demonstrating the encrypted big data collection containers transferred to a file synchronization system for uploading.

FIG. 33 is one embodiment of an example of machine wearable sensors read by the smartphone system combined with crowdsensing data using smartphone sensors fused together into unique collections for transfer to secure cloud backend server containers linked to Big Data, energy modeling, contract compliance applications.

### DETAILED DESCRIPTION

Reference will now be made in detail to embodiments, examples of which are illustrated in the accompanying drawings. In the following detailed description, numerous specific details are set forth in order to provide a sufficient understanding of the subject matter presented herein. But it will be apparent to one of ordinary skill in the art that the subject matter may be practiced without these specific details. Moreover, the particular embodiments described herein are provided by way of example and should not be used to limit the scope of the invention to these particular embodiments. In other instances, well-known data structures, timing protocols, software operations, procedures, and components have not been described in detail so as not to unnecessarily obscure aspects of the embodiments of the invention.

### Overview

Implementations of the inventive system are designed to centralize and segment the logic operation of a network of devices to offer a complete overview of the system, data routes, datastreams and configurations using a global behaviour schema the defines dynamic program logic routes for data functions. The architecture enables the rapid creation of standardized logic components and objects that shares a common structure and flow independent of a programming language. This model makes it easier to upgrade, debug, find bottlenecks, add security measures, downgrade logic and customize and re-write in different runtime languages without massive builds. The runtime environment is language agnostic so it can be implemented in any language and is designed to execute commands in any language formatted into structured lists referred to herein as Playbooks. Playbooks can be organized into Playsets (groups of Playbooks). The Playbook model is similar in concept to media playlists and players.

The Playbook and Playset code development model is essential for secure rapid deployment and customization of different instrumentation applications on many devices. It allows developers to make use of reusable functional logic components that can be assembled inside the Playbook model for execution on different configurations of devices with different resource constraints—memory, storage, multi-CPU and GPU configurations, sensor inputs and other data sources. The focus on assembling functional components using lists reduces the complexity of handling data without limitations on data schemas or database formats. The Playbooks use a database independent JSON format able to be mapped to any input or output sources.

The data used in the system is stored in the form of a Playlist forming a collection of data streams stacked in case collection structure. The data is stacked in the desired manner and can be replayed, parsed, exported and fed to other systems including via a live output feed and distributed between devices on a P2P or server distribution methods.

### On Demand Real-Time

Although the platform is a distributed one where Playbooks are run autonomously on devices, there is also real time support available using various realtime protocols where there are secure connections available between authorized devices in range, and Playbook security and logic allows for multi-device collaboration. The live synchronization is done using a live replication of the database content between peers or a device and a configured server, making event binding possible in many scenarios.

The database scheme is done using tiles of data that are defined by the programmer using an administrative interface to fit the needs of the application and desired playlist results. The use of tiles is designed to maximize data loading in a parallel processing architecture supporting tiled data formats in parallel—GPU/CPU combinations. This format is optimized for multi-array processing in parallel. The data tile formats can be of many forms and levels.

Data and code can be encrypted in multiple protocols. For example, authentication and cross-device communication is done using trust-rings with PGP support to ensure full encryption while everything is done locally within a wireless range or a local area network (no need for server support). There are also many proprietary evasive tactics and algorithms employed based on different static and dynamic data available that devices spread and work together to keep updated. All object request/responses to a deep level of organization provides visibility to any attempted breaches. The programming router system can shutdown malicious code before it can corrupt data or breach the security of any connected systems. A detected breach can shutdown only the section of the network where the threat is detected not the entire system. A secure change can be implemented anywhere in the network without requiring massive changes.

Device security algorithms include any of: (i) I-talk-to-you-because-we-trust-you; (ii) I-dont-trust-you-but-i-read-you; (iii) I-trust-you-but-did-you-work-with-{$device}; (iv) I-want-to-trust-you-show-me-certificate; (v) I-want-to-trust-you-so-i-will-ask-around; and/or (vi) I-want-to-trust-you-but-admin-needs-to-add-you.

Data processing is performed in real time on any device, multi-threaded and with stream checking to ensure no value is lost (data integrity). Correction schemes are also available to allow for proper protocol integration. The event based real-time processing ensures that actions are taken and data is sent when something actually happens and when that data is needed in the new location. The sync, device-device or device-server is performed using a sync logic with the purpose of lowering communication and faults, fast conflict-management and speedy visualization of results within the constraints of a particular device.

The full digest cycle of any incoming data is performed on the fly ensuring and is not dependent on bandwidth, connection speed, router availability, signal range, server response time. The number of streams is known before processing starts, that allows for proper memory and resource allocation to ensure no values are lost during data flows.

Systems and methods described herein may collect data regarding human comfort, environmental, and machine condition at different points in time, from multiple sources or nodes. The data could be gathered in any number of ways including by more than one user device acting in unison or independently as a loosely coupled, anonymous crowdsensing network of devices operating autonomously from each other. In such a way, more than one person, in a crowd-sourced method, could collect and analyze data in realtime from any number of environments with results sent to a shared collection center or distributed onsite centers for storage and further analysis for use in subsequent modification of control systems for efficient environment or machine operation.

In use, such example mobile data processing and analysis nodes can be used by people to map out a large dynamic ever-changing area of any of the metrics disclosed here possible by any combination of internal device sensor inputs and other external data inputs including wireless and wired sensors or network accessible data sources whether they are file or streaming data based. As single sourced data from statically placed sensors can be expensive to gather and less accurate due to many factors including limited deployment of sensors to all of the needed locations, so it may be beneficial to equip many users with collection devices operating in parallel able to collect a rich multitude of data into case collection folders scoped to a location, time and particular set of variables based on input sources.

If those collection devices are things that people might otherwise normally carry, such as a smartphone or tablet, many data points could be gathered and updated on a device for analysis and sharing. Thus, crowd-sourced mapping can utilize more than one person to collect the data and analyze on the spot, and send it to be shared and aggregated into a more complete picture of a given facility or campus-wide environment from different perspectives and locations. For example, in an office building, technical or non-technical staff and residents may be utilizing their own smartphone or provided device which gathers information via a combination of an appropriately scoped application and on board sensory devices combined with a multiple of other data sources using any wireless, file, serial/USB cable or other other form of data stream flow capability into an encrypted fusion data analysis collection which can then be sent to a central server or data center for sharing, further aggregation and analysis.

In such a way, many such people, each with a smartphone for example, could keep constant mapping of a large area requiring monitoring and surveillance, without the need for a single technician to canvas the space with specialized equipment or installation of legacy proprietary sensors and equipment tied to old systems and networking technology in limited ineffective locations. Instead, data collection is taking place by the crowd of less-skilled workers in any necessary location without limitations, and even without proactive interaction by those people.

The fusion of human comfort data generated by fitness or health wearables combined with environmental sensors on the smartphone and other machine sensor media further creates an aggregated case for quick correlation analysis and pattern detection on the device per location then forwards the encrypted result set for group aggregation and analysis by other devices in a peer to peer manner or other forms of content and storage sharing. The ability of the device-based application called a Playbook to create a case collection folder of media data synchronized with correct timestamps and interval length programmable by the user allows infinite combinations of data variables to be captured and analyzed without the need for specific rulesets tied to particular machinery or locations.

Playbooks are a list-based data flow programming and routing container technology designed to execute a flow of dynamic commands in the proper scope with limited security authorizations. The flow of commands orchestrated and executed by the Playbook list logic can be used to capture and record data into a case collection folder with proper timestamps for realtime analysis and visualization. It supports the historical playback of the data based on the historical case collection folder intervals captured during the recording process on the same device or on other devices accessing shared case collection folder data.

The commands executed by the Playbook logic are scanned by the Playbook runtime engine for security violations and the data is constantly evaluated for data tampering by unauthorized sources. Commands include a full set of server type processing capabilities (virtualization of server functions) eliminating the need for making remote API calls to servers for complex processing steps. The elimination of the server calls further reduces the risks of man-in-the-middle attacks to the server compromising an entire network of devices or databases.

The Playbooks are self-contained data flow processes operating in a safe container managed by the runtime system only able to execute authorized and curated commands designed to perform functions from recording data to analyzing the data for rules or applying advanced pattern matching algorithms, generating alerts and visualizing results. The Playbooks reduce the complexity and risks associated with programming data processing tasks for a multitude of combinations of variables—locations, number of devices, number of sensors and data streams. The Playbook safe containers protect upstream multi-user, multi-device data sharing systems from unauthorized tampering and access. It shields and firewalls these systems from downstream local on-premise sensors and other components with possibly unsafe embedded code that could comprise upstream systems if provided direct access.

In certain example embodiments, the data is collected by the individuals on their devices and uploaded to a centralized or local on-premise private server and/or data center without their pro-active interaction (background asynchronous replication of the content). Examples may be an application turned on their smartphone, which works in the background to gather and send data on a continuous programmed interval (for example, every fifteen minutes for a 24 hour period or during a workday session). In such an example, the people are not bothered by such data collection, and do not have to do anything but run the application and keep the device powered on for a given time while data is collecting in a particular location such as a table or in proximity to a single or a group of machines or other equipment. The data can also be collected in a stream for different locations in a building or other space by walking around and activating case collection by location for a specific combination of sensor and external data input including serial, wireless or USB cable data sources.

In other embodiments of the invention, a person can use a custom general purpose or instrument application designed for a specific goal or purpose to collect a case folder collection of a fusion of data from multiple sensors including video, photo, scanned tags, wireless data and other forms of data combined into a fusion data collection case folder. This folder is a unit of workable to be used for capturing a record of conditions based on various conditions including time, location, machinery, people combination of variables. These case folders can be assembled into multiple time-based sequences and replayed just like a video player replays a video file representing a movie or a music file. The case folder collections can be used to construct a chain of sequences over periods of time to evaluate normal and abnormal conditions by time and location. The ability to create a specialized instrument application specific to a particular industry or other scenario quickly using a Playbook programming model is a differentiator from a multitude of other tools which are one size fits all models for all industries representing combinations of multiple physical devices with different use instructions and capabilities.

Innovations herein may be implemented in various way for rapid innovation and is programming language independent. In essence, the system is an advanced dynamic programming language router. For example, a variety of existing language may be utilized to implement the features and functional aspects or components of the inventions, such as LUA, PHP, C, C#, JAVA, GO, Hacklang, Python, Perl, Ruby, NodeJS, etc. Moreover, the invention may be applied to as yet developed programming languages, on top of the base programming routing model using Playbooks. For purposes of illustration, one example JavaScript and HTML commands are used herein below.

The rapid programmability of the Playbook model using, for example, only JavaScript and HTML commands facilitates rapid and safe customization of the core system to support unlimited sensors and data feed scenarios using basic web development methods to orchestrate very complex data flow operations typically done on a network of servers of many types. Other typical systems require the use of a multiple of languages to accomplish tasks from reading and recording data to analysis and visualization of results.

Furthermore, the Playbook model includes the ability to train the system using specific data from a location combined with machines and wearable input so that pattern detection can use used to detect problems rather than coding unlimited number of specific sensor, device, location rules. The Playbook model simplifies and augments known ruleset programming but further simplifies development of complex industrial monitoring applications using a common language (JavaScript and HTML) and universal unstructured proprietary data formats (JSON) to replace complex structured database models. A single language model with simplified Playbook programming model reduces the complexity of programming by magnitudes allowing simple web developers to build complex device instruments and parallel processing data flows previously only done by a combination of embedded multi-processor coders with server coders (many languages and data formats).

The data-driven diagnostic model enabled by the Playbook logic enables more automation of machinery and environments faster than traditional general-purpose equipment requiring skilled personnel or specialized equipment specific to a set of machinery by specific vendors (also a very complex set of tools requiring expensive training and highly skilled personnel).

The Playbook automation model can simplify software tools into a general use model that can be applied to solve an unlimited number of instrumentation application scenarios from monitoring equipment to controlled environments including medical equipment facilities, data center, network equipment closets and research laboratories. Additional Playbook instrument scenarios include the ability to collect case collection folders of data from any structures containing complex equipment including vehicles, airplanes, trucks and boats/ships. Playbook data collection models can also be applied to the collection of operational and condition data from water and other liquid pipelines and equipment having the same sensor data collection capabilities using sensors to capture vibration, acoustics and visual data in the form of video or photographs. Many industrial machines now capture data from visual sources (machine vision). Our Playbook model duplicates the machine vision capability by recording the data into a case collection folder for on the spot analysis and pattern detection and visualization of results.

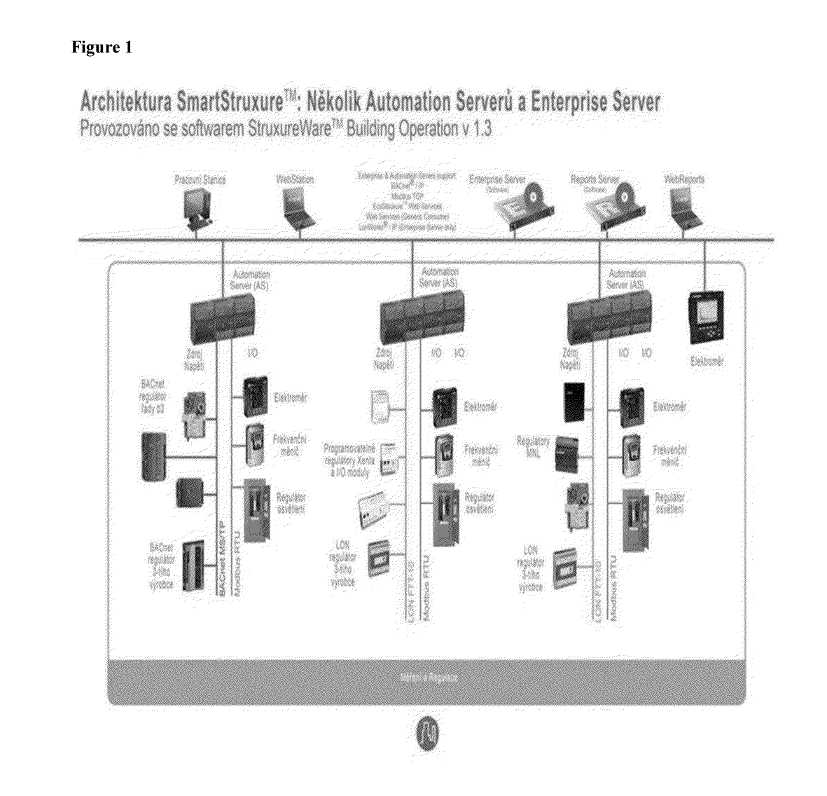

FIG. 1 shows an example architecture diagram showing Architektura SmartStructure™: Nekolik Automation Serveru an Enterprise Server Provozovano se sofwarem StruxureWare™ Building Operation v 1.3 Current heavy IT building automation platform—onsite technology is limited to capital-intensive buildings able to sustain the labor, capital and operating costs and cannot scale down to smaller buildings or distributed locations within large buildings with different environmental and use attributes.

Most modern buildings are now adaptable and changing based on the needs of tenants. Furniture, machinery and workstations are constantly moved and reconfigured creating new demands on energy systems for cooling, power, air and heat. The prior art systems were designed for single use buildings where the environmental conditions and tenant improvements did not change often. These centralized IT heavy systems require massive investment of IT resources skilled in deployment of onsite servers and operation of a complex secure network for the data, applications and static rulesets specific to previously fixed location machinery and sensors within a particular environment or industry. The complexity of these statically programmed solutions reduce the ability to adapt to changing conditions without constant reprogramming of rulesets tied to specific situations. These systems cannot support a dynamic work environment where machines and workstations are in constant state of change of location and usage. The present invention was designed to support these dynamically changing environments and unlimited combinations of data variables captured by a combination of machine, wearable and smart device (onboard sensors) in a highly configurable and personalizable Playbook program designed to collect data into case folders for analysis, visualization and secure sharing.

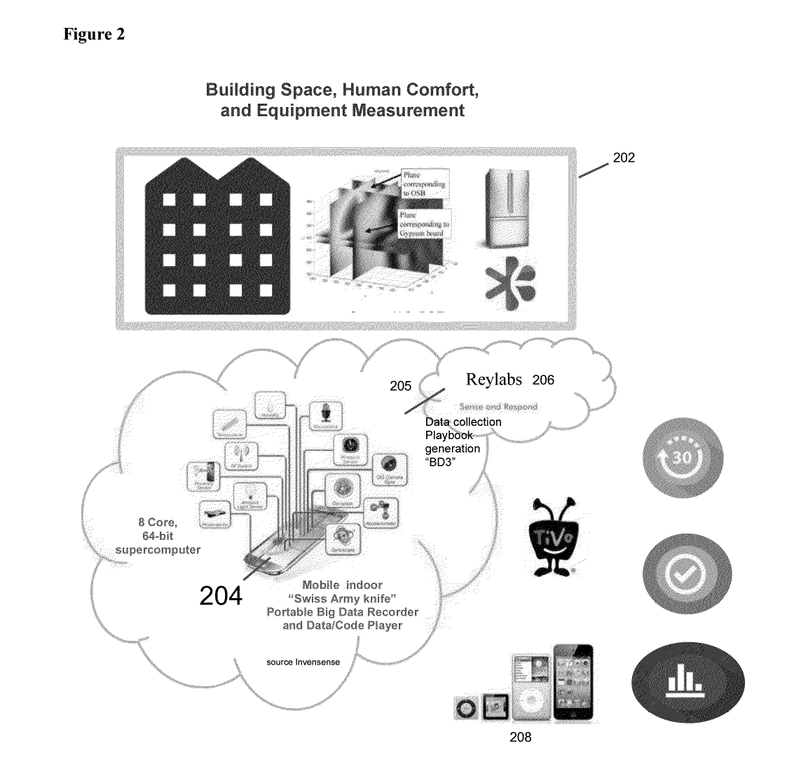

FIG. 2 shows an overall example of how such a solution may be used in such a way to reduce costs of energy efficiency projects and even improve profits. Reduction of cost of installation and service calls may be found by discovering and resolving equipment faults faster in a dynamic changing workplace environment 202 containing many locations, energy systems and equipment. Baselining and monitoring equipment condition, occupant comfort and energy hotspots no matter where the equipment in located without engineers may occur creating normal and anomalous data flow patterns into case collection folders by location. Less skilled workers can collect and analyze the data using the Playbook logic running on powerful mobile devices 204 (smartphones or tablets) to process the data and produce results on the spot in realtime with visualization of the results on the same device used to collect the data.

The Playbook logic can be centrally configured and distributed 205 to groups of devices requiring a specific set of logic. The commands executed by the Playbook lists cover the entire lifecycle for data from recording to analysis, visualization and sharing of any complex data scenario. Unlimited command sets can be combined into specific data flow Playbooks. The runtime environment simulates many server-based API data functions to eliminate or reduce any risky and failure prone dependencies on the network for command execution. The elimination of external network dependencies allows the Playbook to autonomously operate even in areas lacking a network connection.

The device only needs a network connection to synchronize Playbook logic or distributed case collection folders with result and detail data sets for sharing in a network of devices or with a public cloud system in a peer-to-peer mode or via a centralized distribution node 206. In essence, each node can dynamically be configured to operate independently or be loosely coupled with a group of other devices in a shared-nothing data architecture. The Playbook logic is distributed by a control server for a group of devices not the entire network of devices to reduce security risks.

The device runtime uses multi-factor authentication algorithms to uniquely identify the device 208 and its participation as a group of devices of many types. Certain embodiments may allow discovery of investment grade efficiency opportunities (such as those above 30%) and revenue optimization projects without requiring the expensive upfront cost of equipment, sensors and networks.

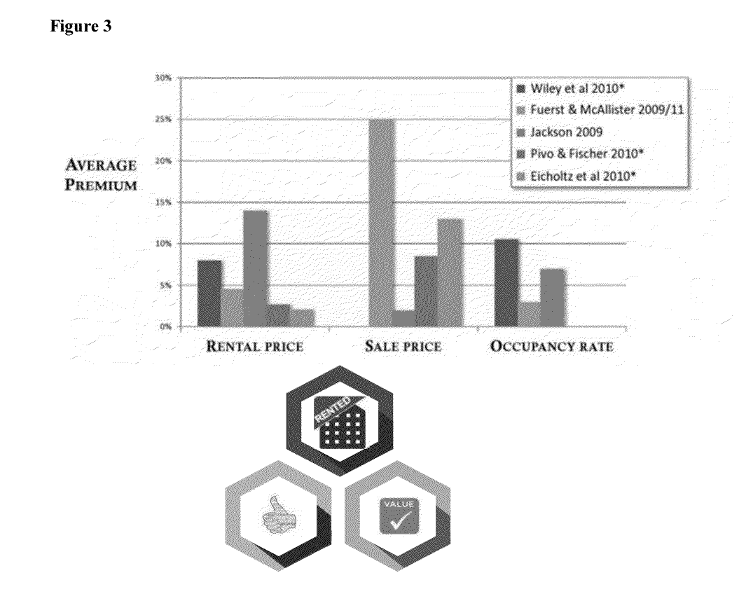

FIG. 3 shows an example graph of some possible benefits of using the systems and methods here reflecting accelerating shared value creation, improvement of the environment and local economy, reduction of carbon emissions, reduction of utility bills for owners and occupants, improvement of accuracy of readings, creation of local jobs, savings of fuel, improvement of occupant satisfaction/revenues, increased occupancy rates and renewals, increased rents with responsive quality services, maintenance of privacy of occupants, improvement of the value of buildings, reduction of operation and regulatory compliance/MV&E* costs, discovery of investment grade energy-saving opportunities faster, increases in sales price, reduction of cost of sales, and reduction time to value.

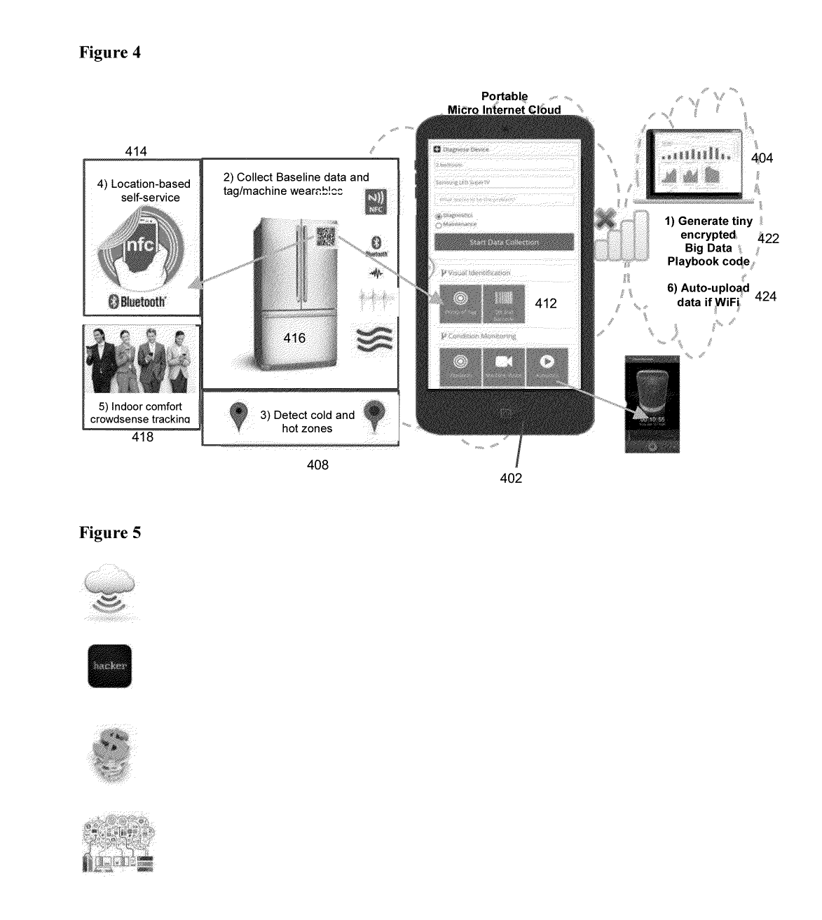

In FIG. 4, server 404 generates encrypted Big Data application code formatted into a self-contained Playbook 422. The Playbook contains the comparable server and database logic to collect and fuse sensor data based on common goals such as energy audit of a space; collection of machine health data in the form of vibration, heat, machine vision, acoustics or other data to determine inefficiencies or thermal conditions contributing to poor building or machine performance. Once playbooks are loaded 424, code can run autonomously and continuously without a connection to the code server resident in the Internet.

Code can be loaded using a user interface 412 with tasks for specific combinations of sensor data collection and analysis repeated as often is necessary manually by pushbutton or scheduled to create collections of fused sensor data we call case collections not unlike the case collections used by law enforcement for evidential purposes. GUI 420 is an example of an external acoustic sensor paired with the device and application to create a sensor input for case collection folders on a handheld device 402. The case collections 408 organize the data for a specific scenario such as collecting baseline data for a particular machine using a combination of wireless sensors attached to the device 416 gathering data into discrete units of measurement of a space, section of a space or personal space of a human occupant, space, pipeline condition and machine measurements, etc. The collected cases created by the playbooks 418 from a crowdsensing network of devices are stored on each smartphone device in an encrypted format for subsequent upload for processing on the server.

Wearable sensor-labels and other machine-attached or internal sensors can generate data to be collected 414 by playbook code using common local wireless protocols including but not limited to WiFi, Bluetooth, RFID, NFC, ANT+ or other. Vibration, acoustics and heat data can be collected from machines into case collections. Adjacent machines frequently cause environmental issues leading to excessive energy consumption or lead to expensive maintenance failures. The same process can be used to collect early data during commissioning of equipment to detect electrical or electro-magnetic interference, improper installation or faulty electrical network connections or wiring.

The use of portable smartphones with their embedded sensors also allow for creation of multitudes of measurement collections to detect 408 hot and cold or humid spots within a building zone areas.

Location-based sensing 414 can be enabled using tags and smart sensor labels for scheduled collection of sensor data. Low-cost sensors become machine wearable devices attached to specific locations on machinery or input/output plumbing or electrical networks collecting measurements disconnected from the Internet or internal networks in difficult to access areas including underground locations. Server-generated code can also be encrypted, printed and loaded into a QR or other machine readable tag to load into smartphone application offline once a machine has been profiled and tagged with smart programmable tags.

The use of smartphones and other portable sensor-based devices can be programmed to create case collections of fused sensor data by a multiple of devices we call crowdsensing 515 by groups of people using devices in multiple locations in parallel. This method allows for collection of personal comfort measurements for space, machines and humans particularly when paired with wearable devices measuring human comfort level—temperature, perspiration, etc. This data can be fused into a case collection combined with environmental sensor data to provide a complete picture of problem situations with cooling, environmental air/humidity and heating systems. 6—created cases are stored in an encrypted container on the device and then loaded using a background service into a secure communication channel using encrypted file storage systems or messaging-based communications able to transport and synchronize storage containers across devices or servers in multiple locations for sharing results sets produced in the form of case collection containers. The background service asynchronously transfers the case collection containers to the secure channel (storage or message-based) and uploads the content when connected to an online wired or wireless connection—3G/4G/2G, WiFi or other

FIG. 5 the current and new generation of cloud-based systems require an always-on connection between server logic exposed as APIs and expensive data connections to sensor or other devices and spaces. There is a risk of intrusion and man-in-the-middle attacks from outside parties into these private networks breaching access control systems, surveillance cameras and other private sensor-based monitoring systems. These centralized systems are also dependent on obsolete or poorly maintained embedded code in many devices and components of systems. Embedded code becomes quickly obsolete and difficult to update particularly if located inside private networks. Many building management systems include obsolete embedded code including Windows/XP, etc. with many known exploits. In essence, these embedded connected codes provide a beacon to the outside world exposing networks to unauthorized access, data theft or saboutage using SSL to protect communications. SSL has been proven to be vulnerable to exploits.

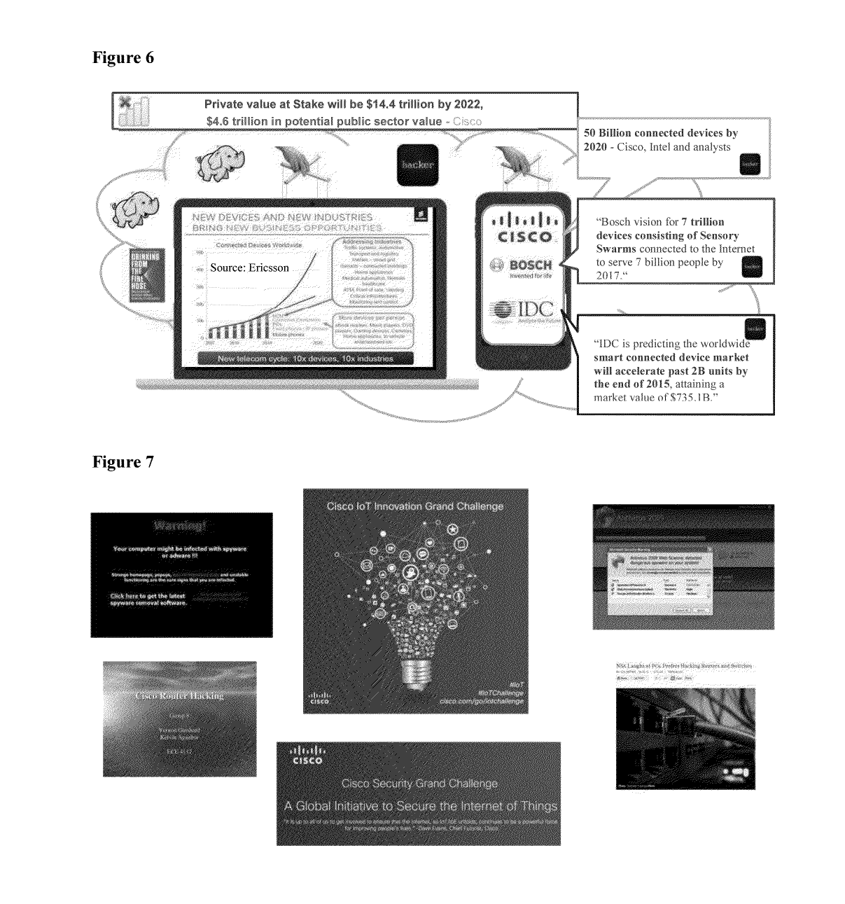

FIG. 6 risks are increasing with the proliferation of devices with embedded code lacking proper security maintenance inside private spaces and networks accessing public cloud APIs and services over unsecured networks.

FIG. 7 millions of routers were hacked in Brazil due to unsupported embedded code in access routers to homes and businesses.

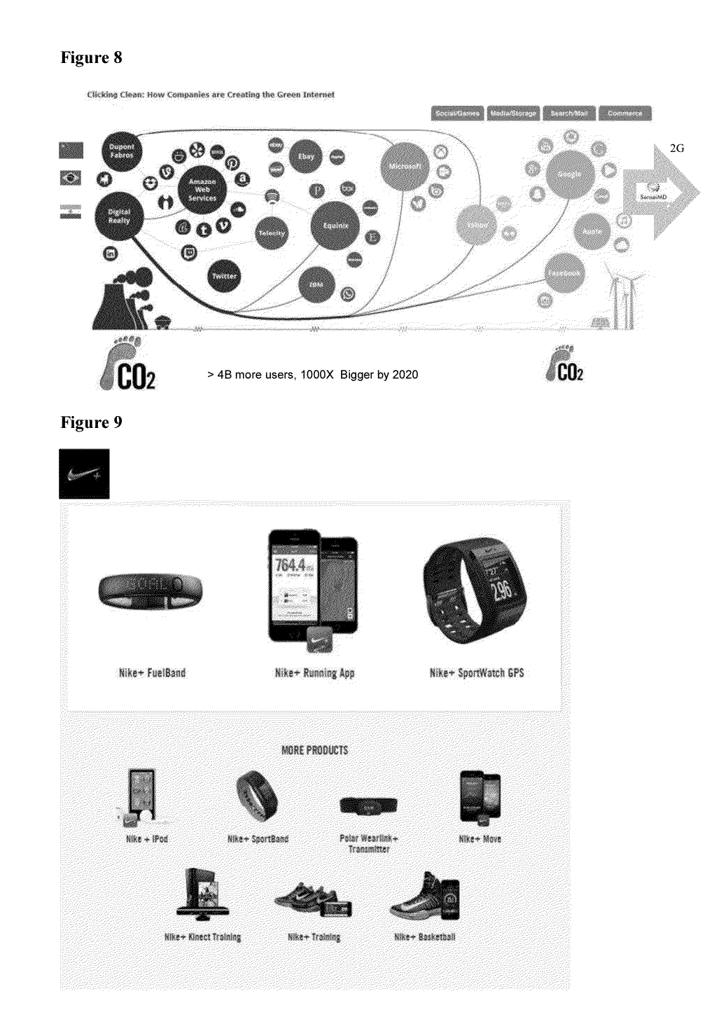

FIG. 8 cloud-based, server-dependent systems also consume expensive data center resources utilizing carbon-based fuels because these expensive servers and network equipment must remain on to support a continuous stream of data from a network of remote devices. The devices keep the servers alive even during low data transfer intervals. A distributed architecture where the main data processing is done on the data collection nodes (portable smartphones and other sensor-based systems) reduces carbon footprints and network connection charges in addition to reducing intrusion risks. These nodes have sufficient processing headroom and internal bandwidth data handling capabilities to handle spikes of data at a fixed cost and energy budget unlike the maintenance of a long chain of equipment and network gear required to service centralized data center processing. There is sufficient computing capacity to perform advanced security functions lacking in less capable devices.

FIG. 9 there are many personal comfort or fitness devices collecting measurements to help optimize human performance. Our system uniquely aggregates the human comfort measurements into case collections fusing data from smartphone environmental and external machine health sensors to create a unique correlated view of heating and cooling issues for particularly locations, machines and human comfort levels. The fused data allows for faster discovery of causes of discomfort—cooling/heating hotspots or machine failures causing excessive thermal, noise or vibration impacts.

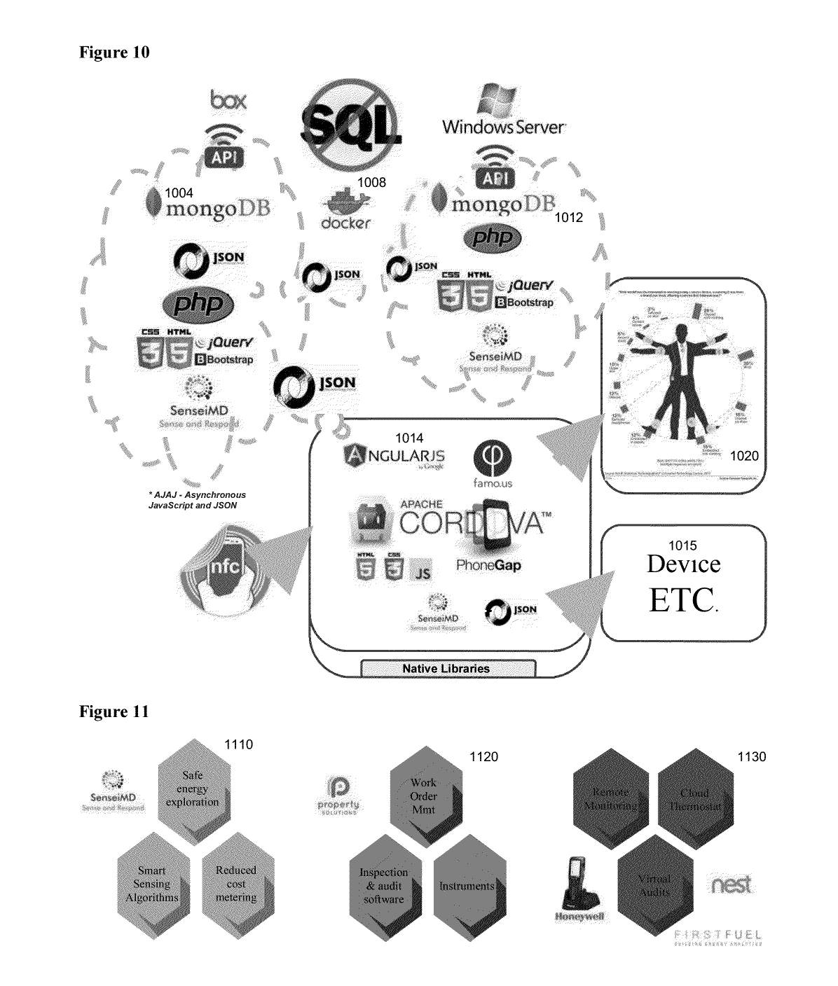

FIG. 10 is one embodiment of the system using a small footprint server 1004, 1012 container resident in a private or public cloud including a NoSQL database, JSON data formats, proprietary PHP server framework code and third-party responsive mobile web libraries. The small server container can generate the mobile code using proprietary HTML and JavaScript macro language and template-based scripts to generate a small footprint portable code we call Playbooks. The device-side Playbooks can run data collection case tasks offline repeatedly until the sensor-based collection node is reconnected with the server for transfer using secure communication channels from wearable devices 1020 or other devices 1015. The small footprint server runs in a server-based container somewhere in the network including virtual machines or tiny server appliances.

In one embodiment, Docker 1008 containers are configured per project, per building or any other natural organizational model to segment data and code generation for security purposes. These containers and their network ports can be activated and deactivated for security purposes to avoid intrusion and camouflage data synchronization and code distribution operations.

In one embodiment of the server-generated code called a Playbook the contents include industry-standard libraries 1014 for mobile user interaction with sensor applications. The code is portable using HTML5 and JavaScript to provide a common language runtime supporting Playbooks on any device capable of running this type of code. The runtime provides Playbooks with a rich set of commands to perform any server task from data collection to visualization without needing to making risky and failure-prone call to external servers. [Table I] are two embodiments of device application code with annotations [Generation 1 Code—APP:] and [Generation 2 APP] and secure server code [Server Code—Core]. The examples demonstrate some of the advanced techniques employed by the dynamic program routing system.

TABLE 1
Generation 1 Code-APP:

| App Code | |
|---|---|
| $routeProvider. | Routes indicate HTML |
| when(′/home′, { templateUrl: ′inspectr/dash.html′, controller: ′Dash′ }). | templates to load and |
| when(′/devices′, { templateUrl: ′inspectr/empty.html′, controller:′Devices′}). | function controllers. |
| when(′/locations′, { templateUrl: ′inspectr/empty.html′, controller: ′Locations′ }). | empty.html has a |
| when(′/upgrades′, { templateUrl: ′inspectr/empty.html′, controller: ′Upgrades′ }). | structure update inside |
| when(′/cases′, { templateUrl: ′inspectr/empty.html′, controller: ′Cases′ }). | the controller to regulate |
| | the caching |
| when(′/diagnostr′, { templateUrl: ′inspectr/diagFull.html′, controller: ′Diag′ }). | |
| otherwise({redirectTo: ′/home′}); | |
| } | |
| if (is_var(navigator.light)){ | navigator.light is part of |
| $max_light = 0; | the proprietary sensor |
| $sparks = [ ]; | frameworks created by |
| $min_light = 0; | reylabs to accommodate |
| $watchLights = navigator.light.watchLight(function(light) { | different needs. |
| // change status | they are also used in |
| $(′#dash_light .s_status′).removeClass(′fa-clock-o′).addClass(′fa-check′); | combinations to generate |
| // get the reading and send it to knob | new types of data, |
| $(′#dash_light .s_knob′).val(light.lux).trigger(′change′); | calculated using multiple |
| // check if max/min and set it | readings simultaneously |
| if ($max_light <= light.lux) $max_light = light.lux; | |
| if ($min_light >= light.lux) $min_light = light.lux; | |
| //write min/max | |
| $(′#dash_light .s_max′).html(′<i class=″fa fa-caret-up″></i> ′+$max_light); | |
| $(′#dash_light .s_min′).html(′<i class=″fa fa-caret-down″></i> ′+$min_light); | |
| // do graph | |
| if ($sparks. length >= $max_values_per_array) $sparks.shift( ); | |
| $sparks.push(light.lux); | |
| $(′#dash_light .spark′).sparkline($sparks, {type: | |
| ′line′,height:′33px′,width:′70px′,fillColor′#cdf}); | |
| }, null, {frequency: $sensor frequency }); | |
| } | |
| if ( isConnected( ) ){ | Some pages need to be |
| $http.get(′http://sensei.ogg.ro/process/app/inspectr.php?devices=all′) | loaded from server and |
| .success(fundion(data, status, headers, config) { | cached on the device, to |
| // show it | avoid reloading and save |
| $(′#ng-view′).html( $compile(data)($scope) ); | server resources |
| // fire it | |
| $scope.runJS( ); | |
| // cache it | |
| writeCache(′page′,$location.path( )substring(1),data); | |
| }).error(function(data, status, headers, config) { | |
| window.plugins.toast.showShortBottom(′Request error!′);alert(′error ′+data);}); | |
| }else if (is_var( getCache(′page′,$location.path( )substring(1)) )) { | |
| $(′#ng-view′).html( $compile(getCache(′page′,$location.path( ).substring(1)))($scope) | |
| ); | |
| pageSetUp( ); | |
| $(′#bcrumbs #bcrumb′).text(′Devices′); | |
| $(′ul[id]=″deviceTab″] a[data-toggle=″tab″]′).click(function (e) { | |
| e.preventDefault( ); $(this).tab(′show′); | |
| }); | |
| }else { $(′#no_connection′).show( ); }// show no connection | |
| $scope.topSensorReadings = function( ) { | The topSensorReadings( ) |
| $scope.watchhumidity = navigator.humidity.watchhumidity(function(h) { | function provides a quick |
| if ($scope.data.avereges[′humidity′] = h.humi) | overview before the |
| $scope.data.avereges[′humidity] = h.humi; | capture process starts, of |
| $(′#sensor_humidity span′).html(h.humi.toFixed(2)); | functionality and values of |
| }, null, {frequency: 2000}); | future server readings. |
| $scope.watchLights = navigator.light.watchLight(function(light) { | It is deactivated once the |
| if ($scope.data.avereges[′light′] < light.lux) | capture process starts. |
| $scope.data.avereges[′light′] = light.lux; | The frequency of all |
| $(′#sensor_light span′).html(light. lux); | proprietary sensors |
| }, null, {frequency: 2000}); | plugins have a resolution |
| $scope.watchpressure = navigator.pressure.watchpressure(fundion(p) { | of 1 ms |
| if ($scope.data.avereges[′pressure′] < p.press) | |
| $scope.data.avereges[′pressure′j = p. press; | |
| $(′#sensor_pressure span′).html((p.press/1000).toFixed(2)); | |
| }, null, {frequency: 2000}); | |
| $scope.watchtempi = navigator.tempi.watchtempi(function(temp) { | |
| if ($scope.data.avereges[′temperature′] < temp.tempi) | |
| $scope.data.avereges[′temperature′] = temp.tempi; | |
| $(′#sensor_temp span′).html(temp.tempi.toFixed(2)); | |
| }, null, {frequency: 2000}); | |
| } | |
| Server Code-Response to app requests | |
| $xx = $bdb->select( )->table(′features′)->show( ); // from USER | Server side code is based |
| $html = $btpl->load(′app/devices′)->data($xx)->show(′html); | on the reylabs proprietary |
| | BD3 framework and we |
| | have added example |
| $owns = array( array(′owner_name′=>′Giulia′,′owner_avatar′=>′img/avatars/5.png′), | code generation to |
| array(′owner_name′=>′Bridge Propery LTD′,′owner_avatar′=>′img/avatars/logo.jpg′) ); | facilitate viewing and data |
| // | display. |
| foreach ($xx as $key => $arr) { | all assets are stored |
| $arr[′power_val′] = | inside the mobile app to |
| implode(′,′,array(rand(20,100),rand(20,100),rand(20,100),rand(20,100), | save bandwidth. |
| rand(20,100),rand(20,100),rand(20,100),rand(20,100),rand(20,100),rand(20,100),rand(20,100), | Additional resources will |
| ra | be cached on request |
| nd(20,100))); | |
| $ow = $owns[rand(0,1)]; | |
| $arr[′owner_name′] = $ow[′owner_name′]; | |
| $arr[′owner_avatar′] = $ow[′owner_avatar]; | |
| $arr[′usage_cycle′]= implode(′,′, array( | |
| 10, rand(8,10),rand(6,8), rand(4,8),rand(4,8), rand(3,8) )); | |
| $fin[$key] = $arr; | |
| } | |
| echo $bloop->html($html)->data($fin)->show(); | |
| Server Code-Core | |
| class Security { | Every string of data in or |
| // change this on install to prevent world domination | out of the reylabs |
| | proprietary |
| protected $mykey =′ <secret>″; | framework is checked for |
| // don't change after install, you will die | a large combination of |
| protected $_xss_hash; | malicious code, multiple |
| protected $_never_allowed_str = array( | methods of intrusion, |
| ′document.cookie′ => ′[removed]′,′document.write′ => | possible passing of |
| ′[removed]′,′.parentNode′ => ′[removed]′,′.innerHTML′ => ′[removed]′, | unauthorized payload that |
| ′window.location′ => ′[removed]′,′-moz-binding′ => ′[removed]′,′ =>′!;!--′ | can affect data. |
| => ′--&amp;lt;′, --′>′ => ′-- &amp;gt;′, | |
| ′<![CDATA[′ =>′&amp;lt;![CDATA[′,′<comment>′ => | |
| ′&lt;comment&gt;′); | |
| protected $_never_allowed_regex = | The security knowledge |
| array(′javascript\s*:′,′expression\s*(\(\|&\#40;)′,′vbscript\s*:′, | was acquired over time by |
| ′Redirect\s+302′,″(\″)?data\s*:[\hat{ }\\1]*?base64[\hat{ }\\1]*?,[A\\1]*?\\1?″); | our team, while using |
| protected $words = array(′javascript′, ′expression′, ′vbscript′, ′script′, ′base64′,′applet′, | diverse development |
| ′alert′, ′document′, ′write, ′cookie, ′window′); | environments. |
| protected $naughty = | |
| ′alert\|applet\|audio\|basefont\|base\|behavior\|bgsound\|blink\|body\|embed\|expression\|form\|framese | |
| t\|f | |
| rame\|head\|html\|ilayer\|iframe\|input\|isindex\|layer\|link\|meta\|object\|plaintext\|style\|script\|textarea\|titl | |
| e\| | |
| video\|xml\|xss′; | |
| protected $more_evil = | |
| ′#(alert\|cmd\|passthru\|eval\|exec\|expression\|system\|fopen\|fsockopen\|file\|file_get_contents\|readfi | |
| le\| | |
| unlink) (\s*)\(( *?)\)#si′; | |
| $iv_size = mcrypt_get_iv_size(MCRYPT_RIJNDAEL_256, MCRYPT_MODE_ECB); | The main encryption |
| //get vector size on ECB mode | model is done using |
| $iv = mcrypt_create_iv($iv_size, MCRYPT_RAND); //Creating the vector | RIJNDAEL 256 salt & |
| $cryptedpass = mcrypt_encrypt (MCRYPT RIJNDAEL_256, $this->mykey, $string, | pepper encryptiption. |
| MCRYPT_MODE_ECB, $iv); | The large IV size, |
| | encryption model and use |
| | of special and very |
| | special characters makes |
| | it very hard for direct |
| | attacks in case of data |
| | interception. |

Generation 2 APP

| App Code | |
|---|---|
| $compileProvider.aHrefSanitizationWhitelist(/\hat{ }\s*(https?\|file\|ftp):/); | The initialization of the main module that controls |
| $sceDelegateProvider.resourceUrlWhitelist([′self,′http://reylabs/w | the app also contains security methods to limit the |
| eb | use of remote requests only to authorized servers |
| _app/inspectr/′,′http://reylabs/process/app/**′]); | and loads the multi-language module that allows |
| $translateProvider.useStaticFilesLoader({ prefix: | for instant translation of all text present inside the |
| ′/js/i18n/′,suffix: | app, at any level. |
| ′.json′ }).preferredLanguage(′en′).fallbackLanguage′(en′); | |
| $scope.watchers[′humidity′] = | The $scope.watchers array contains all the |
| navigator.humidity.watchhumidity(function(humidity) { | sensor readings at a global level inside the app, at |
| $scope.outputSensorReadings(′humidity′,′#humidity′,humidity.hu | a predefined frequency and prevents conflicts |
| mi.t oFixed(1)); }, null, {frequency: $scope.rFrequency }); | between functions when demanding sensor |
| | readings |

Minimal dependencies are made with native machine code required to access hardware. JavaScript functions can access native machine sensor functionality and perform advanced caching of server content without the need for server logic after the caching is completed during a connection with the server. Multi-layer security is employed to guard against intrusion or tampering of code and data. Our security system employs many advanced techniques to detect security issues including continuous code scans for known attack methods and detection of data tampering. Any device 1015 with basic HTML 5 and Javascript processing capabilities can support Playbook code including wearables, drones, robotics, PCs, embedded computers, appliances, etc.

FIG. 11 shows an example diagram of how certain embodiments may provide non-invasive, secure micro application platforms that provide low carbon footprint and are able to scale up or down based on need without heavy IT investments. Such examples may be hybrid secure mobile data/energy exploration and monitoring that exploit broad range of opportunities now, maps energy hotspots, enables self-service and lowers costs.

FIG. 11 also shows how other systems not embodied here such as a “react and scramble” format may be labor intensive and create backlogs of data. The mobile manually inputted inspection checklists used in such examples do not scale and are subjective opinion reports require great levels of skills by the operator unlike Playbooks containing pattern detection and general-purpose data collection methods.

In such examples, little to no machine data is collected and it can be invasive, and use heavy carbon footprint remote data center centralized monitoring. Further, the costs may be prohibitive, constrained by setup, with hackable unsafe server-centric networks. A cloud thermostat is even stuck in a fixed location, and detects problems late. It is a single point of data and could provide a security risk if continuously connected to a public cloud server.

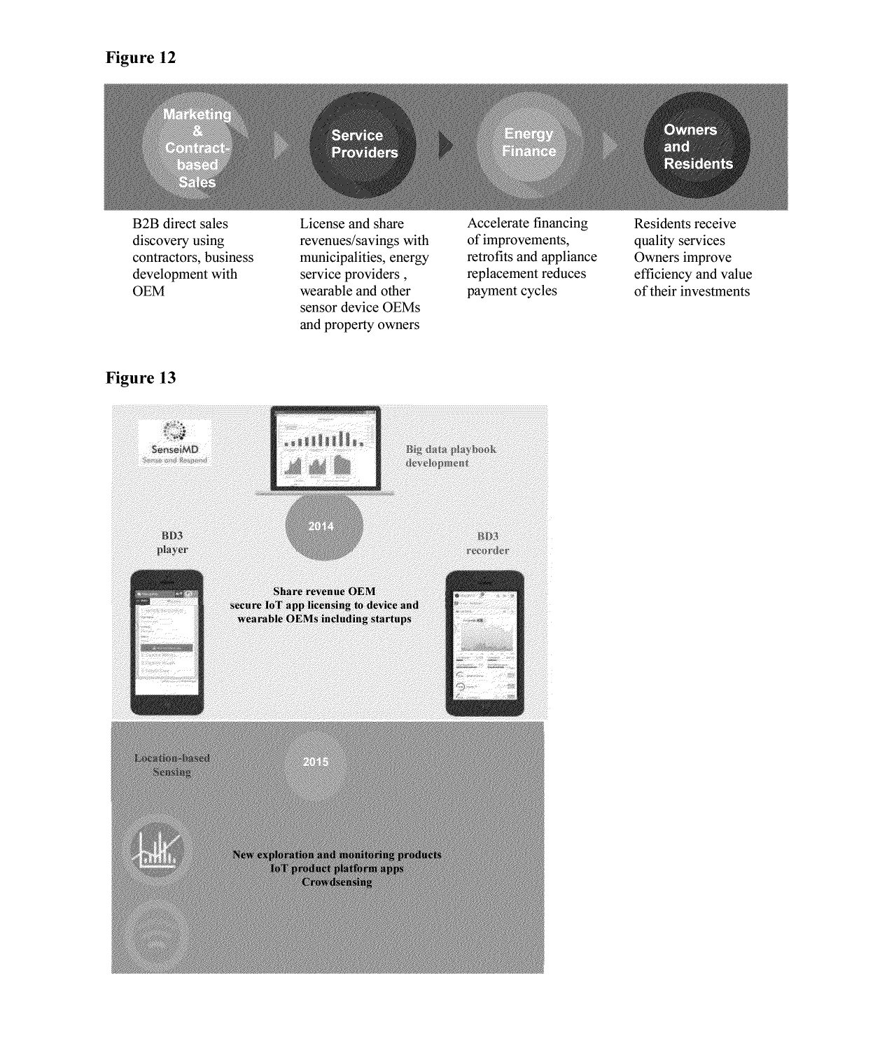

FIG. 12 shows an example of use and possible benefits of embodiments described here. The example shows a Marketing & Contract-based Sales with B2B direct sales discovery using contractors, business development with OEM. It shows a Service Providers which may allow Licensing and share revenues/savings with government inspectors, municipalities, energy service providers, building or facility service providers, insurance companies, wearable and other sensor device OEMs and property owners. Energy Finance which may accelerate financing of improvements, retrofits and appliance replacement reduces payment cycles. And it shows Owners and Residents which may allow residents to receive quality services and owners to improve efficiency and value of their investments.

FIG. 13 one embodiment of the invention packages the system into a big data collection recorder and big data collection recorder Playbook applications. The BD3 JSON data format is a big data collection using JSON formatted media objects with ability to share and transform the objects into formats compatible with external systems including building measurement, auditing, compliance and business intelligence (Big Data). The invention employs crowdsensing meaning multiple portable devices can act as energy and environmental metering network systems to collect more granular level data than stationary metering devices with limited proximity and context.

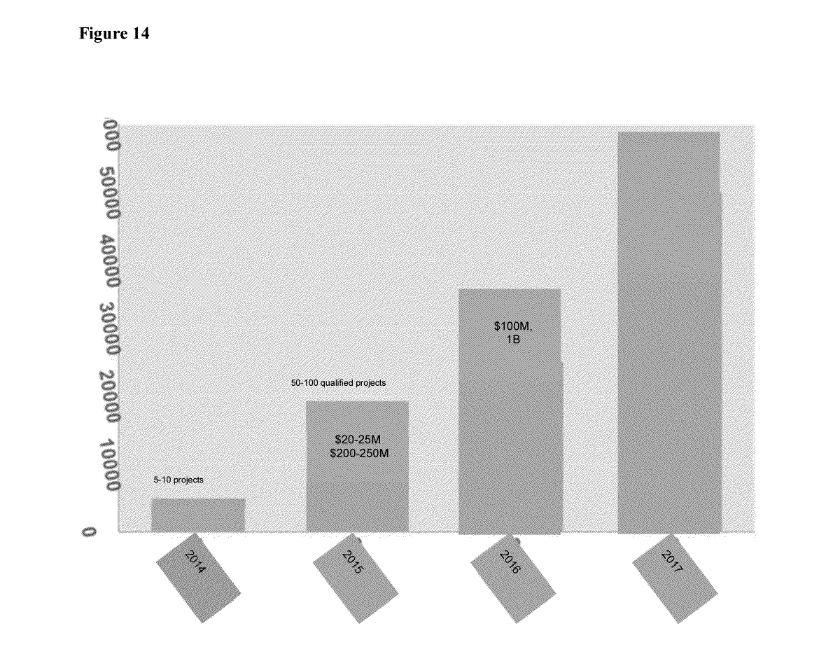

FIG. 14 demonstrates the fast value creation using the invention due to reduced capital and expenses associated with energy audits and monitoring and verification. Up to 100% of the processing can be offloaded to fixed price devices in the network changing the economics of monitoring, analyzing and visualizing data results all without costly networks or servers. Servers are optionally used for performing analysis of the shared data and also sharing results with other devices using synchronization of many types. The case collection folders are represented as normal file objects so the data content can be distributed using any file transport or synchronization method including EMAIL, FTP, messaging, file synchronization, etc.

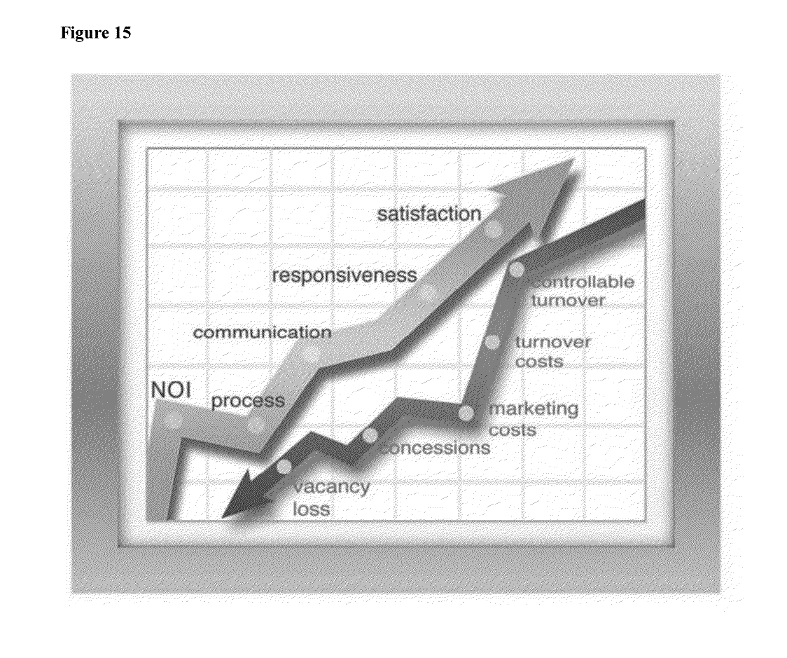

FIG. 15 represents the value created by improvements to building machine maintenance leading to improved tenant/resident comfort with the reduction in negative effects such as turnover or vacancies.

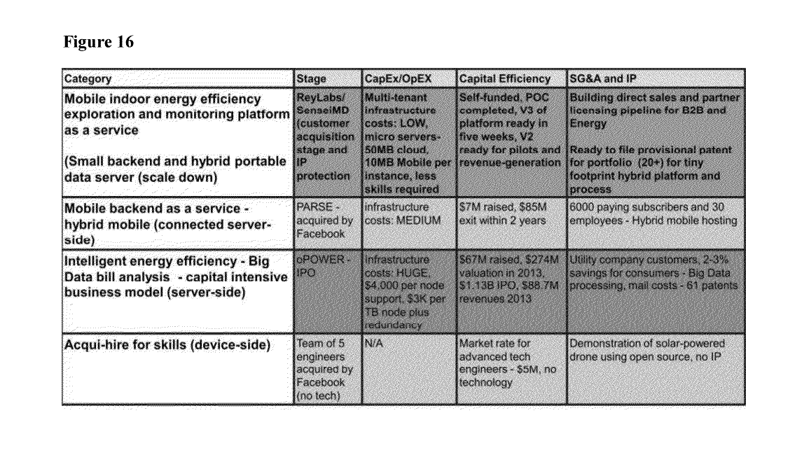

FIG. 16 this table compares various business models including the one enabled by this invention called mobile indoor energy efficiency exploration and monitoring platform The reduction of dependencies on IT assets and skilled labor required to accomplish energy tasks is contrasted by the business model of invention and status quo business models requiring IT capital and other expenses. The present invention changes the capital requirements for servicing a network of locations and machinery. Less skilled resources at reduced market rates can perform tasks previously delegated to highly skilled personnel. Fixed price low cost devices can replace the use of expensive network and data center resources.

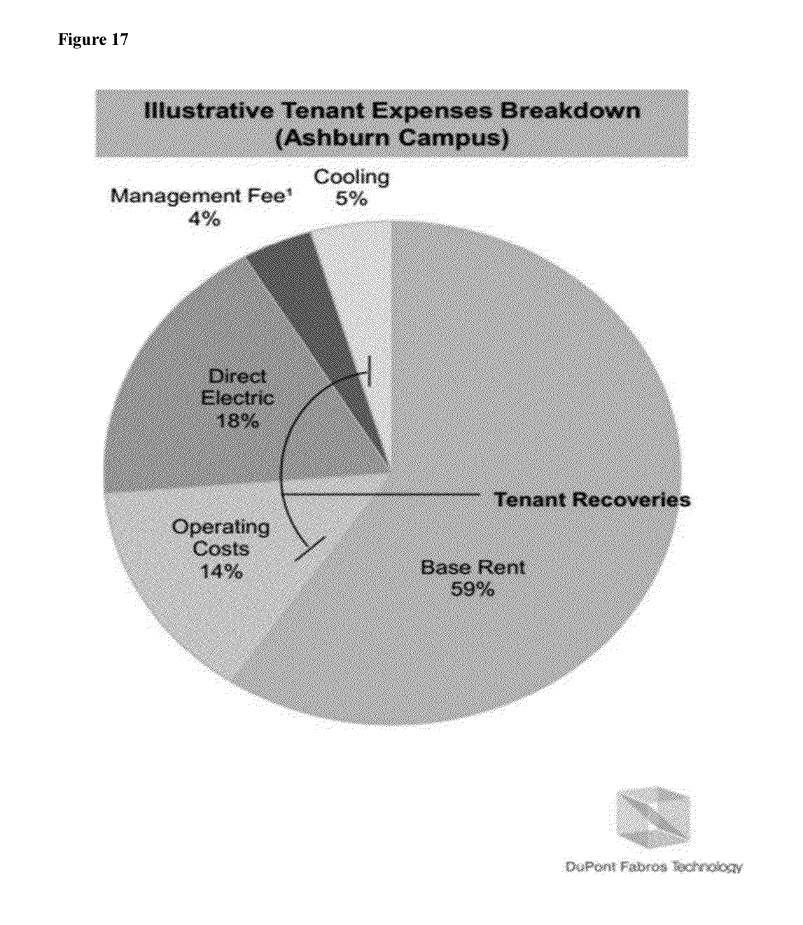

FIG. 17 represents a data center tenant revenue generation for a real estate company for data center service companies. Tenants spend almost 40% of the costs in energy, cooling and operating costs due to complexity of the operations. Most of these costs are reduced by invention by reducing the excess demand on the data center for data-intensive sensor data collection, fusion, aggregation and transmission costs.

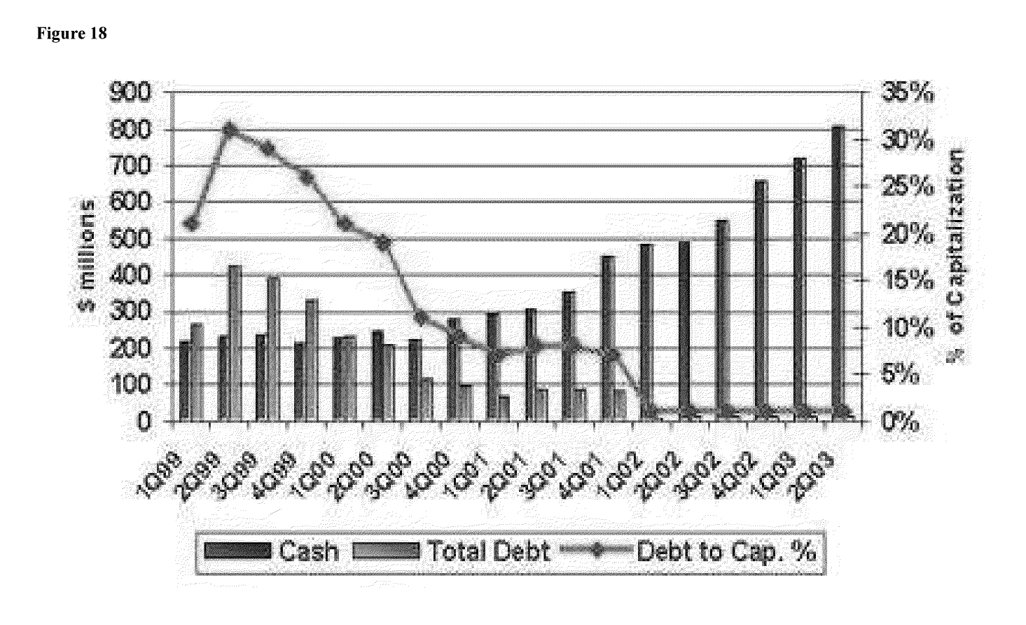

FIG. 18 is an example of efficiencies obtained using cloud-based systems for a supply chain. Similar efficiencies can be gained from the efficient utilization of assets.

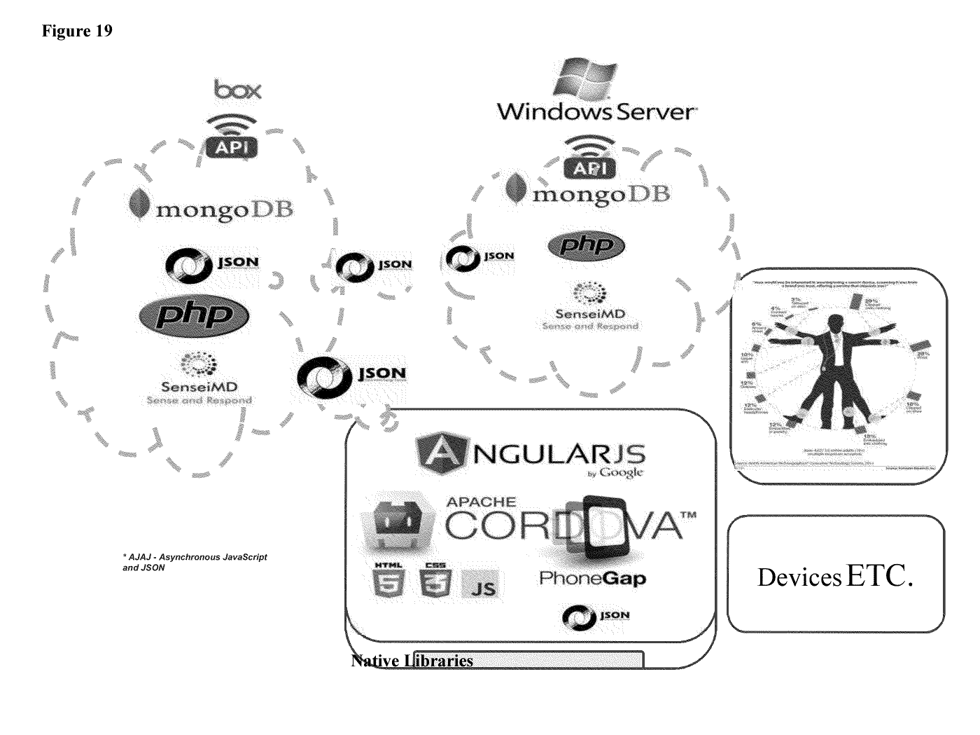

FIG. 19 is another method for integration of the server containers with external storage systems represented by public cloud companies such as Box and a legacy hosted Windows server for a building management system The common data exchange format is a proprietary data collection based on a stream of JSON formatted objects.

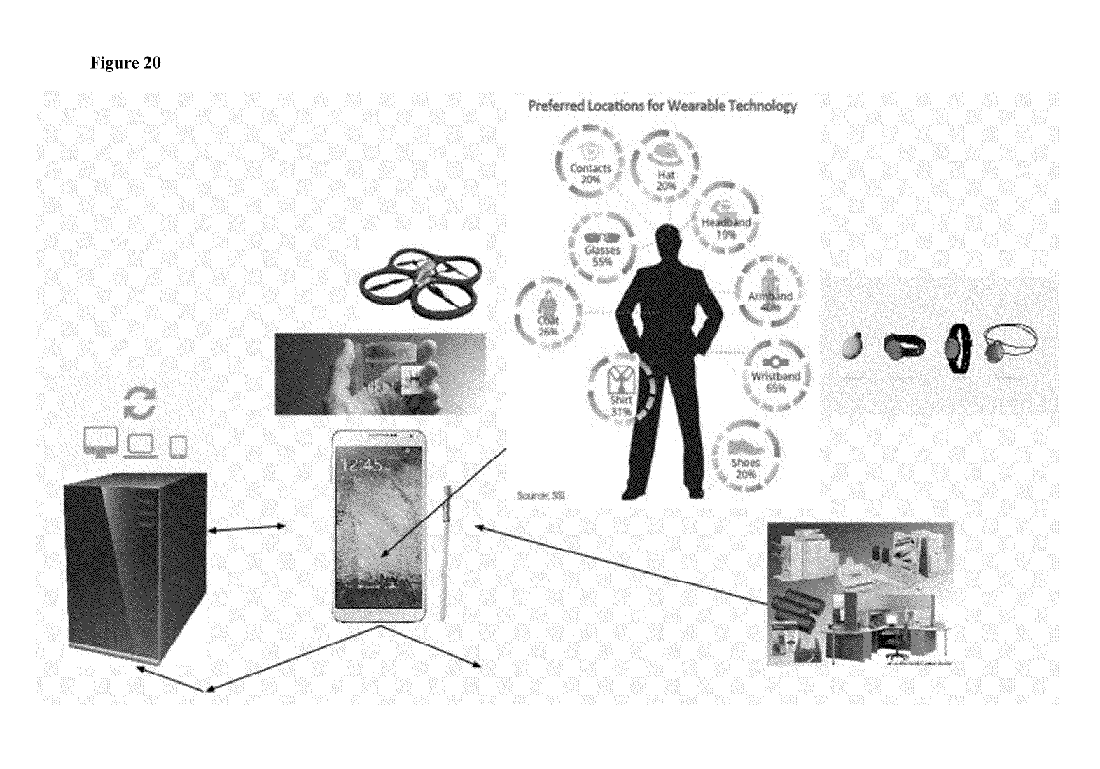

FIG. 20 in one embodiment of the invention there is a variety of sensor-based devices and sensor-labels fused with data from human wearable devices to provide a complete picture of machine, human and environmental energy consumption and comfort. Other embodiments may include drones, robots or other portable sensor-based devices. The central processing unit for the multitude of sensor inputs is shifted from data centers with servers to handheld portable devices or onboard computers running the Playbook logic offline and disconnected from the network. The data only synchronizes with the network when there is a connection and when it is necessary to exchange data with other devices or update the device code over the air.

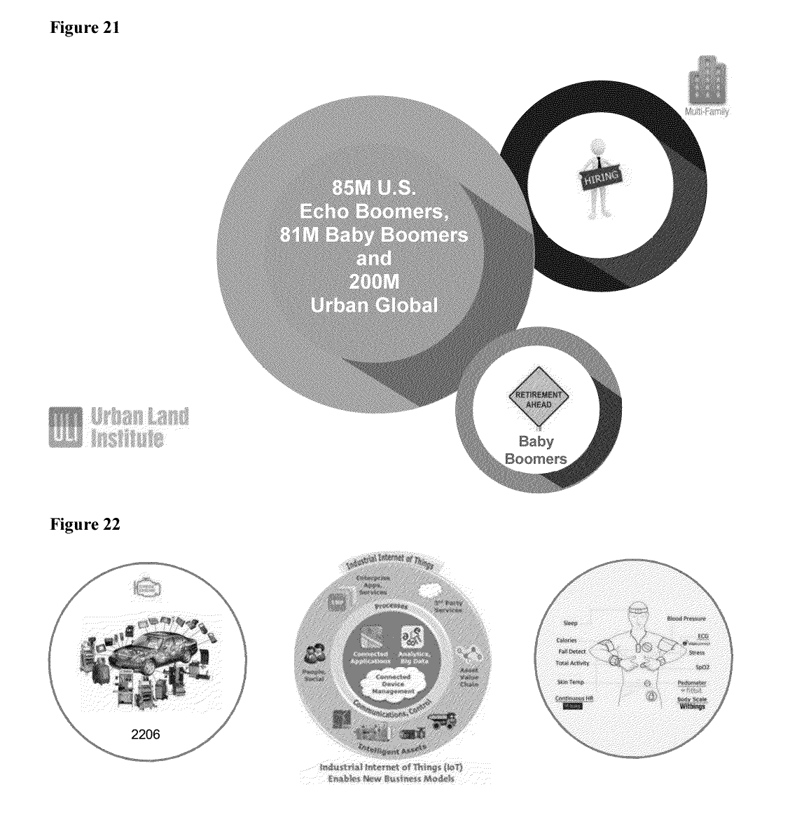

FIG. 21 shows an example chart of connected housing market exploding which may lead to less homeownership, population with less mobility, more multi-generational buildings, more energy efficient buildings, smaller units which are closer to transit and have mixed-use.

FIG. 22 shows example diagrams showing proven short-range diagnostic technology models not unlike the smartphone sensor model employing Playbooks. An automobile 2206 contains many sensors with complex logic to synthesize and evaluate the data onboard without the need for external server application connections. The network of sensors can be evaluated by external diagnostic programs. The short-range diagnostic model is employed in human wearables, automotive and certain condition-based maintenance activities using proprietary instruments in the industrial and commercial sectors. The present invention provides a method to provide improved levels of instrumentation services without the industry specific device approach used in the past.

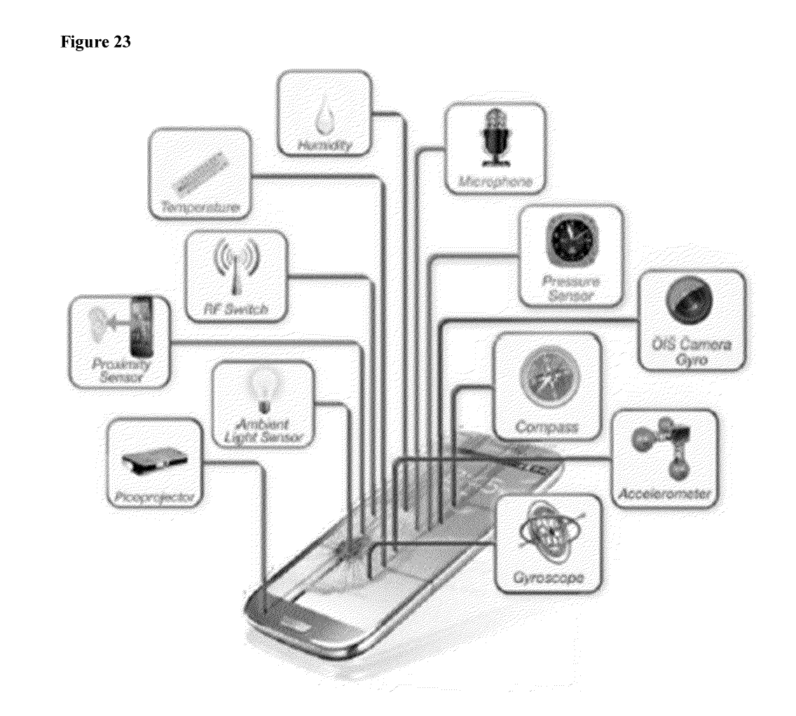

FIG. 23 demonstrates the rich variety of human comfort, machine and environmental sensors used by the invention to reduce IT costs. A typical smartphone or tablet device includes a multitude of automotive class sensors not unlike those you find in a modern vehicle. The sensors can be programmed for many uses including collection of weather, human activity and now machine and other environmental data when used by Playbook logic.

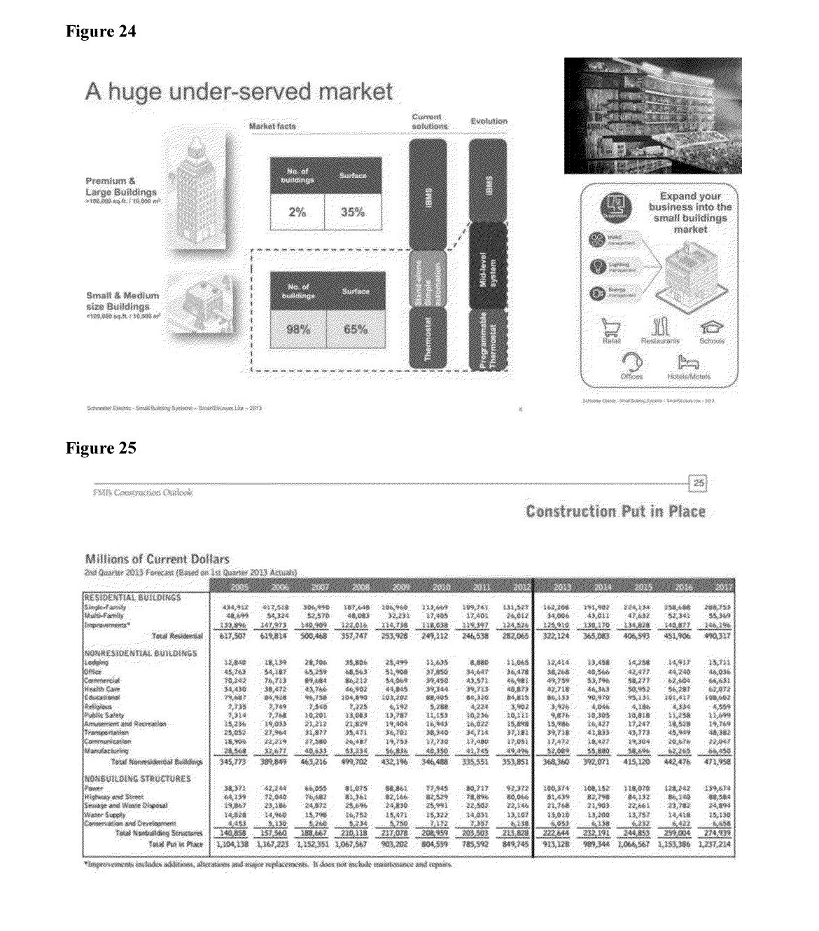

FIG. 24 shows an example of Secondary Markets for the invention—Mixed Use Buildings which could be an under-served market. This may be because there are so many small and medium sized buildings taking up much more surface area on the planet than premium and large buildings. Thus, if the systems and methods here were used not only in the premium and large buildings, but also small and medium buildings, it could be even more beneficial. Smaller buildings do not have the resources to conduct a traditional IT-heavy energy audit due to upfront costs. The present invention reduces the barriers to adoption of data-driven diagnostics and instrumentation of spaces and machinery by eliminating the dependencies on expensive IT resources and services.

FIG. 25 represents the investment of assets in different classes of infrastructure. Assets are undervalued based on low levels of energy efficiency. Improving asset efficiency levels has a profound impact on the value of facilities and the economy while reducing the overuse of energy and water resources.

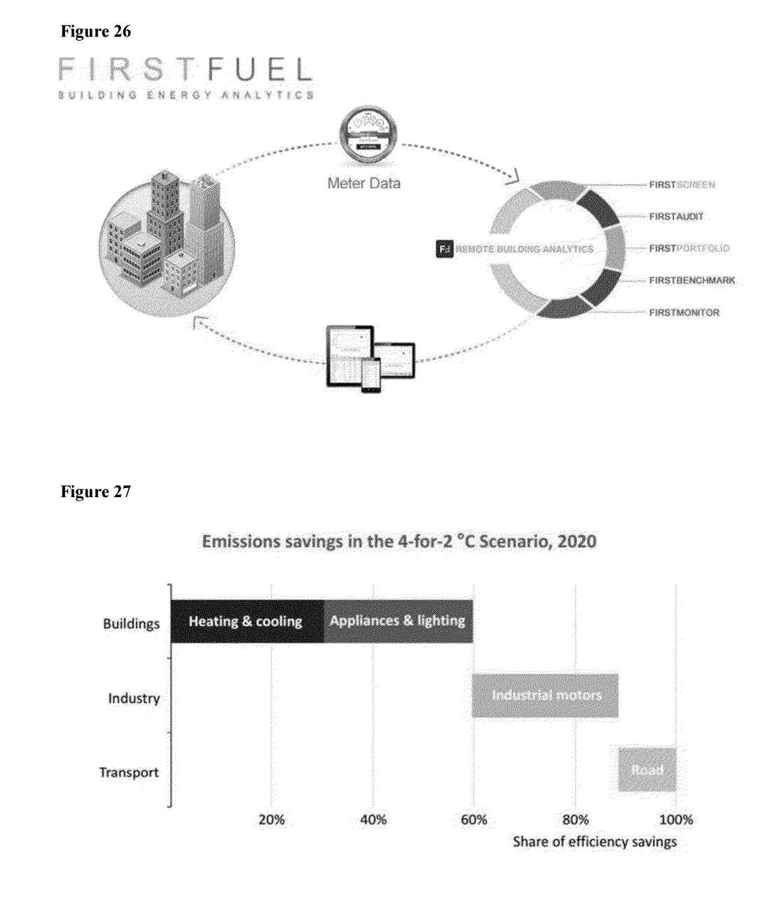

FIG. 26 shows an example where existing fixed remote services are dependent on meters and fixed thermostat readings. These readings provide an analysis of the performance of a building from the outside in. They cannot evaluate causes of energy waste or human discomfort. The present mobile device software invention can go inside buildings and investigate problems with machinery, environmental conditions without limitations on a single data source.

FIG. 27 shows an example chart showing possible benefits for a multifamily unit including improved energy efficiency, energy efficiency reduces emissions by 1.5 Gt, led by minimum energy performance standards—and additional investment is more than offset by fuel bill savings.

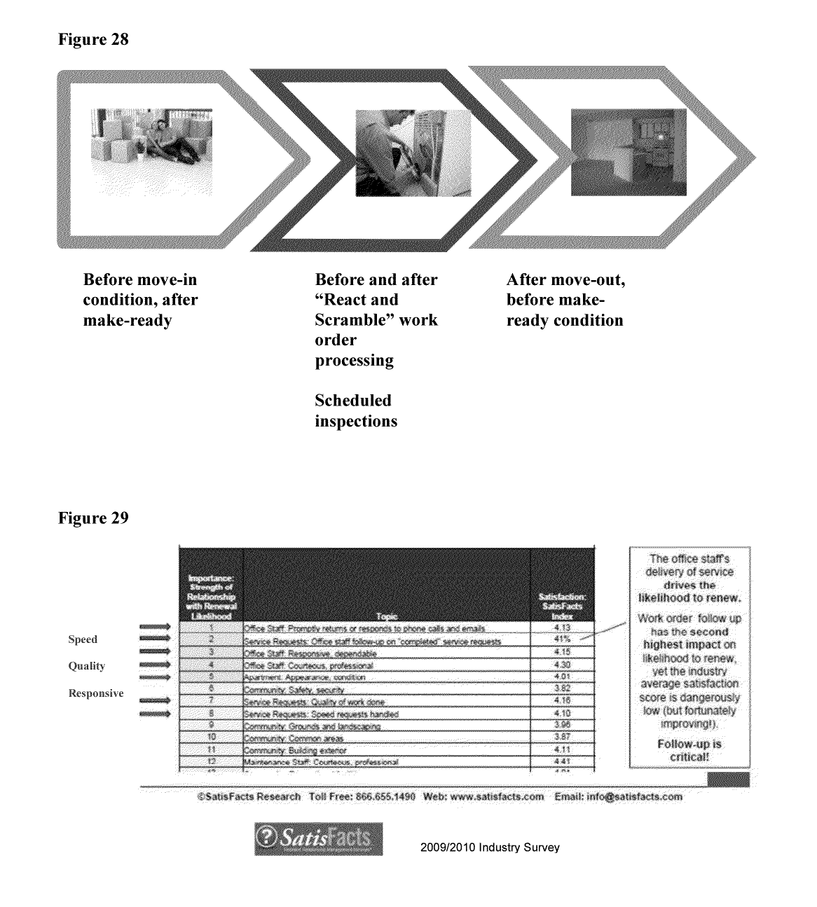

FIG. 28 shows examples of how such systems and methods here could be used in different residential environments. First, the system could be used to monitor quality at every stage. Next, monitoring before move-in condition, after make-ready. Next, before and after “React and Scramble” work order processing. Also scheduled inspections. And finally after move-out, before make-ready condition. This model applies to any commercial or industrial facility where there are co-owned or multiple owner equipment and machinery installed in the facility. These activities also apply during, before and after installation and commissioning of customer premise equipment of any type, in any industry.

FIG. 29 shows an example chart of an Industry resident survey with renewal factors affected by poor maintenance and energy efficiency issues. The optimal case is where data collected by maintenance personnel during routine scheduled inspections identifies the need for pro-active maintenance instead of relying on tenant notification or machine or equipment failure.

Data Collection and/or Analysis

Data collections, once collected from the various crowdsourced devices, can be packaged, aggregated, fused and encrypted in a secure container and uploaded from such a group of devices, via wireless communications such as WiFi, cellular, and/or short range such as Bluetooth to the internet. From the internet, the systems may gather and undergo further aggregation of the data for analysis and transfer to building control and other operational or business intelligence systems, in essence, the system performs many tasks traditionally run on expensive server-based Big Data nodes. Thus the system operates as a shared-nothing Big Data node consuming a negligible amount of resources compared to traditional data center resources.

The data being collected and analyzed may be indicative of any number of things which may be aggregated into a fused data collection for further analysis. Examples include but are not limited to service interruptions, human discomfort, energy waste and/or service quality issues in a given space. This data may also be useful for enabling preventive maintenance operations and/or reducing diagnostic time for machine during installation/commissioning of buildings including heating, ventilation and air conditioning (HVAC) systems. It can also be used to fine tune scheduled energy system parameters controlling cooling and heating. The data can also be used to discover the source of heating and cooling problems whether it is caused by machinery or other causes.

This data may also be relevant for normal operations of buildings such as office, home, mobile homes, ships, yachts, business, or industrial It could be used in transportation such as in trucks, automobiles, or planes. Further example locations where the systems and methods described herein may be used to collect such data may include industrial complexes, restaurants, commercial offices, multifamily and single-family homes, home garages, hotels, vending machines, data centers, production lines, rooftops (for example for HVAC and solar), basements, interiors of ships/yachts, airplanes, trains, trucks, and cars, etc. This list is illustrative of locations, but it is not inclusive of all scenarios. The systems and methods described herein may be employed anywhere a device with sensors can go.

Data may include not only measured metrics of the environment but also data about the physical environment such as a ground floor plan for a building or other space. Tracking of the steps followed by the user of the devices could be used to map out a given space and the measured information from those places could be coordinated with the mapping and other sensor data. The cross reference of data and location data may be used to more accurately map the data by aggregating it into a collection for upload for further processing. In such a way, the nodes may monitor data and fuse the environment maps, or be used to measure 2D and 3D space efficiently.

FIG. 23 shows an example smartphone device, capable of collecting data using a myriad of sensors, for example, but not limited to measuring humidity, temperature, air pressure, vibration, proximity, ambient light, magnetic fields and radio frequencies. Measuring sensors could be included such as an accelerometer, gyroscope, camera, pressure sensor, light sensor, RF antennae, microphone and compass. Certain embodiments could come with a projector as well. Device sensors could also be remote from the device, such as wearable sensors, and in communication with the device via NFC, BacNet, ANT+, Bluetooth, all IEEE 802.15, or others. Proprietary sensor arrays could be used with timed collection capabilities and live feed/alert. External machine vibration, acoustics, thermals, and other diagnostic data may be collected in addition to environmental and human comfort data from wearable devices on human occupants of a building or other space.

FIG. 4 shows an example diagram of how data collection may take place. In this example, a big data recorder and player apps operate anywhere on a device. The Playbook code is generated from the server in the form of tiny encrypted Big Data Playbook code compatible with Big Data and other enterprise systems. They may collect baseline data from a tag a machine wearable device (sensors attached to machines) or a wearable sensor. The location-based devices may be self-service and correlate data sensed with location. The machine wearable sensors can be smart tags containing encrypted, stored versions of Playbook code and data for reading by the smartphone applications. Cumulatively, this may result in indoor comfort crowd-sense and/or crowd-sourced tracking of energy consumption and utilization. The data may be automatically uploaded if connected to a wireless such as WiFi network.

FIG. 5 shows an example diagram of some platform, skills and environmental limits that could be found. Connectivity to central cloud and Big Data centers may be used. Security at site and device may be used. The result could be limited to costs and energy consumption for just an app and content data distribution. Certain complexity may require specialized engineers/PhDs to collect, analyze and process the data.

### Big Data and Internet

FIG. 6 shows an example diagram of a hypothetical Connected Internet of Everything (IoE) such as the internet in the future. The figure shows Private value at Stake could be $14.4 trillion by 2022, $4.6 trillion in potential public sector value. It shows 50 Billion connected devices by 2020. For example, “Bosch vision for 7 trillion devices consisting of Sensory Swarms connected to the Internet to serve 7 billion people by 2017.” And “IDC is predicting the worldwide smart connected device market will accelerate past 2B units by the end of 2015, attaining a market value of $735.1B.” From Cisco, Bosch and IDC analysis. There are many security risks associated with connecting devices with embedded code that can become vulnerable to intrusion or other malware.

FIG. 7 shows an example diagram of screen shots dealing with security vulnerability of existing embedded systems such as Internet home or office routers. Embedded code frequently becomes obsolete allowing intrusion from Internet hackers.

FIG. 8 shows an example of what may be termed Silicon Valley's “Dirty Secret” dealing with Big Data, and Big Costs associated with all of the 3 billion users by 2014. More than 4 billion more users, in other words 1000× Bigger by 2020 will drive up consumption of coal-burning resources to power always-on Big Data servers at a cost of thousands per node (support, hardware and services).

FIG. 9 shows an example of Nike and how “Between 2005 and 2008, power consumption at Nike's main data center in Oregon grew 15 percent faster than Nike's revenue (measured by compound annual growth rate).” These growths indicate a lack of linear scalability based on the current web architectures with connected devices dependent on server connections and data transfers and processing.

FIG. 10 shows an example of a Valuation Driver: In the example, Rich IP Portfolio fixes IoT problems. 5 MB micro “Big Data” AJAJ templating system (PHP). Secure HTML5 content flow model and malware filtering protocols protect against XHR and SQL injections. HTML5-based schema-less development (less skills). Encrypted machine playlist labels. Security is 3-level authentication. Portable Big Data Player. Portable Bid Data Recorder. Portable Data Playbook (data and code playlists). Virtual metering features and algorithms. Mobile asynchronous “Big Data” objects (AJAJ) avoids persistent connections (data and code). Dynamic encrypted, minimized code loading. Supports any micro sensing device—wearables, drones, robots, smartphones. Near wireless secure AJAJ communications. Sensor fusion algorithms. Machine and vehicle wearables. 3D parametric HTML5 data mapping. Supports 2G to 4G.

FIG. 13 shows an example of how the data could be utilized to accelerate contract-based performance energy projects. For example, in the Business Model Goal enabled by the invention: $25M by end of 2015, assuming contract-based revenues per energy projects, 8-10% for sales acceleration ($5-10M); durable subscription monitoring revenues (10 yr); and a license Platform.

FIG. 14 shows an example diagram of how use platforms may be used to jointly develop and license products. Platform licensing (developer tools, player and recorder) may be used. Facebook, fb: Scale down costs for the Next 5B users using UAVs, robotics, wearables and smartphone as Internet platform for Big Data, energy reduction. NTT: Scale down 5-8M legacy connection IoT devices and supply chain/vending machines and accessories. Energy Apps (direct sales and licensing). Eaton: Replace front-end archaic Windows audit and monitoring product line with a service (retrofit building backlog). Such usage may result in 50% energy reduction by 2020-50M square feet (SJ) includes affordable housing 8-10M square feet (Fremont) 49M square feet (Vancouver).

FIG. 15 shows a chart of possible benefits of using such systems and methods including increased NOI, process, communication, responsiveness and satisfaction. These may come with decreased controllable turnover, turnover costs, marketing costs, concessions and vacancy losses.

FIG. 16 shows a table of example Comparables including Advanced Tech/Big Data Energy.

FIG. 17 shows an example pie chart of Illustrative Tenant Expenses broken down on an example place. Attractive Triple Net Leases with Long Duration. Multiple streams of payments from tenants with Base rent, Operating expenses, Direct electric, Management fee, Tenant reimbursements minimize tech risk and Data center revenues. (1) Calculated as (Base Rent+Operating Expenses)×5%. Real Estate at the Speed of the Internet.

FIG. 18 shows an example chart of StorageTek/WorldChain (from R Gil patents)—Cloud-based service efficiency track record—Performance-based Contracting By Bill McBeath Benefits may be found where the numbers tell the story: Automatically replenished materials went from 2% to 85%; Total floor space reduced by 42%; WIP in factory reduced by 41% in the first six months; Overall inventory reduced by $100M over a two year period; Turns increased from 3.9 up to 7.3, with a goal of 12 for 2003; Almost tripled cash and brought debt virtually to zero (see FIG. 2); http://www.chainlinkresearch.com/parallaxview/case/study_storagetek.htm; Dark Side of Internet of Everything. In Brazil, 4.5M routers were compromised for purposes of security fraud. The result is hundreds of millions of devices that have been silting on the Internet, unpatched and insecure, for the last five to ten years. Chief Technology Officer of Co3 Systems, a fellow at Harvard's Berkman Center, and a board member of EFF. https://www.schneier.com/blog/archives/2014/01/security_risks_{—}9.html

FIG. 19 shows an example Virtual Metering IP Portfolio that may be used to Connect On-Demand. For example, HTML5 secure NoSQL content-flow programming may be used. Portable “Big Data” JSON database may be used. Project-based server-generated mobile measurement apps—dynamic code refresh may be used. HTML5 3D data mapping may be used. Parametric 3D model support may be used. Sensor energy data fusion may be used. Energy exploration process models may be used. Condition-based monitoring of machines may be used. Supply chain monitoring may be used. Smart encrypted code tags for machines may be used. Wearables for cars and machines may be used. Smartphone and wearable crowdsensing/crowd sourcing network may be used.

### Infrastructure/Architecture

FIG. 20 shows an example architecture diagram showing smartphone Playbook application system as the center of the sensor network as a data collection and aggregation node. The sensor network includes a secure channel to the server using secure messaging or secure storage. Sensor data can be collected with paired wearables on a human. Machine health data can be collected using the smartphone-based sensors placed close to any variety of mechanical devices susceptible to overheating, vibration or noise pollution caused by failing components. Vibration data can be collected to perform condition monitoring of machines and fused with environmental data and human comfort data to quickly diagnose the cause of environmental and energy consumption problems.

The systems and methods described herein may employ one or more computers, such as smartphones, tablets, phablets, wearable computers or other portable or fixed devices comprising or capable of interacting with one or more sensors either on board or in communication with the devices. These computer devices, and associated sensors in some embodiments, may multiplex big data collection and send to aggregation nodes using a secure channel (storage or messaging). API and SQL-based channels are minimized to avoid detection and provide an opportunity for hackers. Many available smartphones or other devices may be used, but a node can be any portable or fixed sensor-based wireless or connected node of a proprietary or off-the-shelf design. Nodes may even include vehicles such as cars, trucks, bicycles, or planes, and could include aerial indoor and outdoor mapping drones, satellites, robots, health and fitness wearables, nano-size and tiny computers, 3D mapping computers, etc. Nodes may also be scaled down versions of sensor-loaded smartphones for emerging markets with costly data connections and lack of Internet resources and skilled labor. Overcoming these IT limitations allows for more energy exploration in markets with constrained resources of every type.

Certain embodiments may include where some nodes are used for unattended monitoring offline for data collection by other nodes. Rules may allow for timed collection, alert generation, real-time feeds, “look for” capability to “expect” a reading in sensors, programmable sensor labels, sensor arrays, etc. Readings may be obtained using secure local wireless protocols (near field wireless) in some cases. Operations may be run offline and data may be sent by pull to prevent exploitable protocols inherited from dependencies in some cases. Multiplexing data collection aggregation nodes may exchange data using secure protocols, hidden formulas, validation schemes, expected meta tags, and/or other security measures.

Certain embodiments include the ability of the container-based server to generate Playbooks for proprietary protocols such as BACNET with rules designed to optimize zones for energy utilization, security or other.

As stated above, the data could be sent from the collection devices to one or more servers (e.g., secure cloud project data and code generation node servers) may run in secure isolated multi-tenant cloud data centers hosting server containers in some embodiments. Each server container may only share secure file sync channels with appropriate devices. The isolation of server containers from each other at a project level reduces the security risks. Containers may be scheduled to be activated and deactivated at random times for security reasons (e.g., camouflaging server resources). A common exchange format may be used. For example, the format may be based on AJAX (asynchronous Javascript and JSON). Decoupling server resources from multiplexing data exchanges and limited device access may reduce security risks and resource consumption, may allow for downtime-free updates, and may prepare data for advanced analysis and storage. Algorithmic security policies may govern these evasive server provisioning and orchestration maneuvers on the server and the autonomous offline Playbook applications. Remote wipe functions can be activated to destroy Playbook application code and data if the device is lost or stolen.

Location independence and server (cloud independence) may allow the systems and methods described herein to multiplex and fuse data from any location, any device, any sensor type—inside and outside buildings and other locations on the ground, sky, space, moving vehicles, etc. with or without a cloud connection. Data collection nodes may operate at a low carbon footprint because of decoupling processing from servers and big data distributed file systems and infrastructure. The invention allows unlimited scalability due to its shared nothing Big Data compatible node architecture. Data may be used for optimizing energy use, comfort levels, and/or machine performance to reduce energy consumption and thermal effects impacting the environment (heat, for example). Data collection nodes may process data at reduced carbon-footprint due to decoupling of application and data processing from server resources.

In some embodiments, data may be transferred from a node to a server upon regular pull requests to file and message sync system. Upon a pull request, new uploaded packages may be checked, format may be validated (e.g., <secret> and media files), and a check may have a formal request on client side. Authentication methods may include basic HTTP AUTH, user/pass+device UUID/UID, previous hash( ), and/or fresh hash done with <secret> formula, for example. In a pull to process, data may be processed (e.g., status may be updated, pack for new pull from device may be generated, and notifications may be issued (if real time)). File sync and messaging systems may employ high levels of data integrity and security. Multiplexing data transmissions may be started automatically in the background when connection is available. File sync system may be a storage or secure message-based platform designed to move multiple media types. For example, a pull operation may be as follows: onConnectionDetected( ) authenticate & sync data containers from servers or devices.

Sync multiplexing of big data case collection containers (e.g., sensor fusion data) may be processed, for example using a BD3 proprietary data object exchange format. Package validity may be checked, for example by checking hash format against formula, checking HTTP response code, checking received headers (<secret>), and/or checking char position according to (<secret_formula>). Data may be validated. Data content and data collection encoding may be performed. Secure lossless data compression container for any type of data (e.g., media, binary, text, etc.) may allow portable data exchange with any JSON-based data systems on devices or the cloud. A case collection container may contain a mix of multiple data types (e.g., video, audio, text measurements, binary, etc.). Mission critical data may be encrypted using <secret> adaptive formulas and military grade encryption Device/location/cases (details, usage, location, rules, access, partner, history, status, upgrades) may be among the mission critical data that is encrypted. Processing rules may include scrubbing data containers for potential malware or detection of tampering, code injection, modified headers, unexpected/unallowed commands, etc. Data validation, compression, aggregation, and processing tasks may also be done locally in accordance with playbook sets received from server, task split/hashing, processing needs, server batch or online server resources, etc. System components may only connect when necessary; this may camouflage system from others and/or may minimize device and server resources to unauthorized use and access.

An energy and machine diagnostic playbook may run connected or offline (non-invasive). Code may be encrypted, obfuscated/polymorphic dynamically-generated code with locally scoped data and rules (e.g., share nothing node architecture). Code may be generated and refreshed by server when data collection and aggregation node connects with cloud server. The playbook may include loading device. Loading device may include applying rules of use and/or allowing/denying sensor data collection. The playbook may include starting multiplexing sensor data fusion diagnostics (e.g., fuse data from multiple sources). Diagnostics may include sensor by sensor diagnostics with screen indications and/or diagnostics of data recorded and stored locally. The playbook may include collecting space measurement data using step counters and visual space mapping techniques and secure collection and data fusion/compression algorithms (e.g., for camera, steps, acoustic measurements, and/or laser camera distance measurement sensors). The playbook may include saving to encrypted local storage for future transfer to secure cloud storage channel. During some scenarios the playbook can be used to monitor compliance with corporate, personal, or government regulations for energy efficiency, safety, or other items of interest. When a diagnostic is done, the playbook may include saving data to big data case collection container storage on devices for transfer to secure file synch storage channels. Big data containers may be packaged into safe containers for multiplexed file synch transmissions. Dynamic server-generated playbook code and data may be isolated from device embedded code for security purposes. Code may be device-independent HTML5, JavaScript, JSON, and/or other portable code and data formats. Code footprint may be small, allowing for playbooks to run on any web-capable device. Playbook code can include advanced micro server and big data object processing logic compatible with online servers.

A machine and environment big data case list (e.g., playbook processing) may be generated. The list may include active cases, recently collected cases, options to edit/remove details/data, and/or sync options. The list may include commands (e.g., sync case collection). Commands may include, for example, move packed data file to file or message server, move media files to file or message server, and/or sign with <secret> metadata. Server may be configured such that ifConnection( ), start sync with main file or message server.

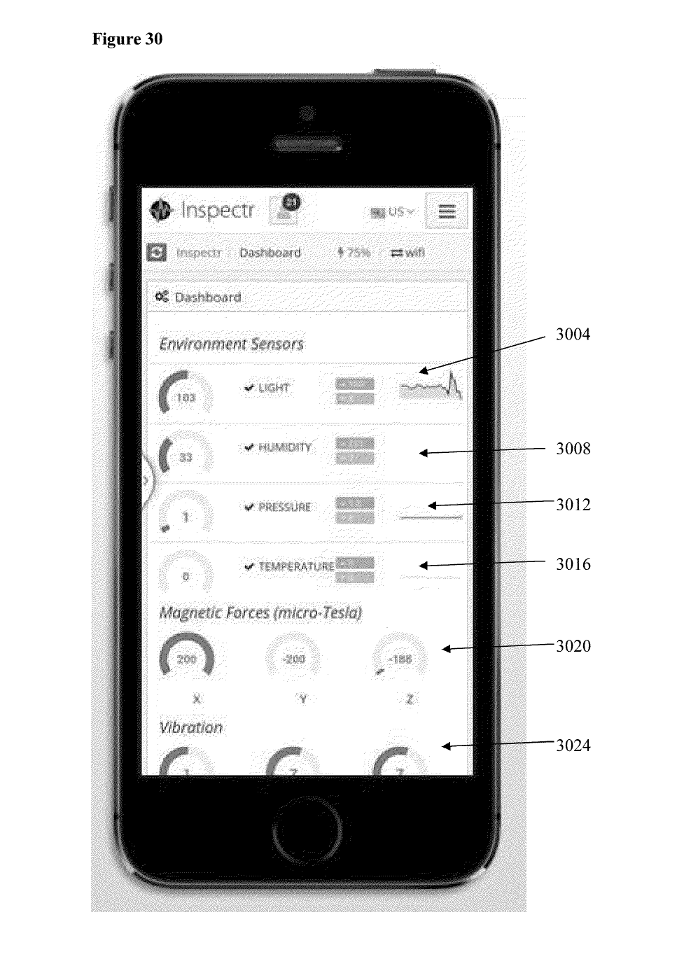

FIG. 30 shows an example screenshot of a graphical user interface GUI on an example smartphone produced by Playbook logic. In this example, the user interface for a device such as a smartphone, tablet, or other computer may be provided. The user interface may display data captured by environmental sensors that may be part of or in communication with the computer. For example, FIG. 30 shows light readings, humidity readings, pressure readings, temperature readings, magnetic force readings, and vibration readings. Any combination of these readings or other readings may be possible and selectable by the user creating a wide variety of case collection possibilities for many combinations of internal and external sensor data inputs unlike static programmed scenarios. The readings may be generated by sensors such as light sensors, humidity sensors, pressure sensors, temperature sensors, magnetic sensors, vibration sensors, etc. The monitoring may be non-invasive and portable and may be used to diagnose problem areas and machines anywhere the computer can be deployed. The device could upload the data in order to be aggregated in a crowdsourced way (e.g., exchanging data with other devices) for analysis. Magnetic force readings 3020 can also be captured providing visibility of interference from electrical devices, networks, etc. Magnetic readings can also be used to determine if devices are malfunctioning generating excessive magnetic signals.

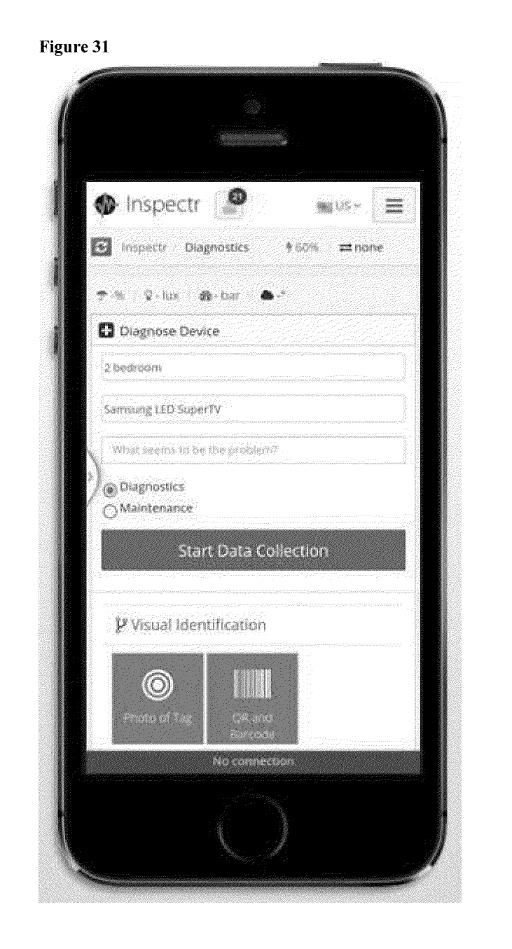

FIG. 31 shows an example screenshot of a diagnostic case collection GUI which may also provide access to diagnostic and/or maintenance features even to low-skilled people not trained to perform advanced diagnostics. Tasks can now be assigned to less-skilled people to collect data on the spot in a comprehensive and structured manner for sharing with skilled personnel in short supply. A skilled resource can now be fully utilized while offloading less-skilled tasks to others thereby increasing the capacity to collect and analyze more data. This data-driven diagnostic approach can eliminate and predict many conditions leading to possible catastrophic failures. For example, a user may be able to perform diagnostics on other devices and machinery and electronic devices.

In FIG. 31, the user interface displays a dialog for selecting a device (e.g., “Samsung LED SuperTV” in a bedroom) and starting data collection (e.g., light readings, etc.). The user interface may also provide visual identification of devices, for example though photo identification and/or barcode scanning identification. This diagnostic/maintenance interface may be used to identify potential energy improvements, complete audits, and/or verify contract-based improvements, for example.

The Playbook controls the dialogs and actions driven by user interaction and also triggers other actions based on data flows. It is designed to simplify complex data flow automation, processing, conversion and analysis in one cycle resulting in a realtime display of results. The Playbook is a self-contained application designed to eliminate dependencies on network-based application services resident on multiple remote servers. The present invention packages these self-contained applications into a Playbook format similar in concept to a read-only music playlist where the logic flow is defined in a list format.

The invention runtime engine scans the code and safely runs the application to perform data-driven tasks similar to a media recorder application (data recorder) or data visualization player able to display realtime data as it is processed by the Playbook logic or “rewind” historical data and review it not unlike video players play and control video playback on a device. Any data task can be performed in this manner only limited by the internal resources of specific devices. Most devices in the market today employ multiple processors and graphic processors in one unit allowing for advanced parallel data operations to be performed on a stream of data coming in from multiple sources. The powerful parallel processing capabilities allow Playbooks to dynamically and intelligently schedule parallel data activities optimizing the data flows according to the constraints of the system.

Structuring the data tasks in the form of lists allows our runtime to dynamically make these adjustments without the need for programmers to understand these complex tasks or be concerned about limitations of different runtime device environments. Furthermore, the runtime also eliminates the complexity of secure programming from the lists. Web developers with limited skills can construct complex data flow automations simply by assembling the list of commands to be executed as part of a data flow pipeline. They do not need to be concerned about unsafe coding practices leading to server security breaches or data risks.

The runtime transparently protects the Playbook code from malicious tampering and handles ultra-secure communications and data exchanges with the servers while employing the most advanced multi-factor authentication and other security schemes too complex for most programmers to understand. Abstracting the complex away from the tasks of programming data flows allows a wider web developer force to be used for these tasks rather than specialized combinations of highly skilled programmers ranging from embedded coders to server and database coders. The reduction in complexity also reduces debugging of complex flows because commands are pre-packaged and pre-tested functional components to be scheduled by the Playbook logic in the most optimal way.

Underlying native code can also be wrapped with JavaScript functions to facilitate scheduling in the Playbook system. All of these abstractions simplify the tasks of performing end-end automation of data flow tasks from collection and recording data into case collection folders to analysis of the data, visualization of results, alert generation, data encryption and sharing. Most of the complexity is handled transparently on behalf of the programmer. One of the benefits of this approach is that read-only playback versions of data can be distributed in a proprietary format for viewing by a runtime Playbook in another machine. This safe method of content distribution and sharing can be done even inside a Smart TV with the ability to execute JavaScript and HTML browser code. The content inside the case collection folders can only be accessed by an authorized program using our runtime environment and security keys ensuring safe exchange of private data containing machine, environmental and human sensor readings.

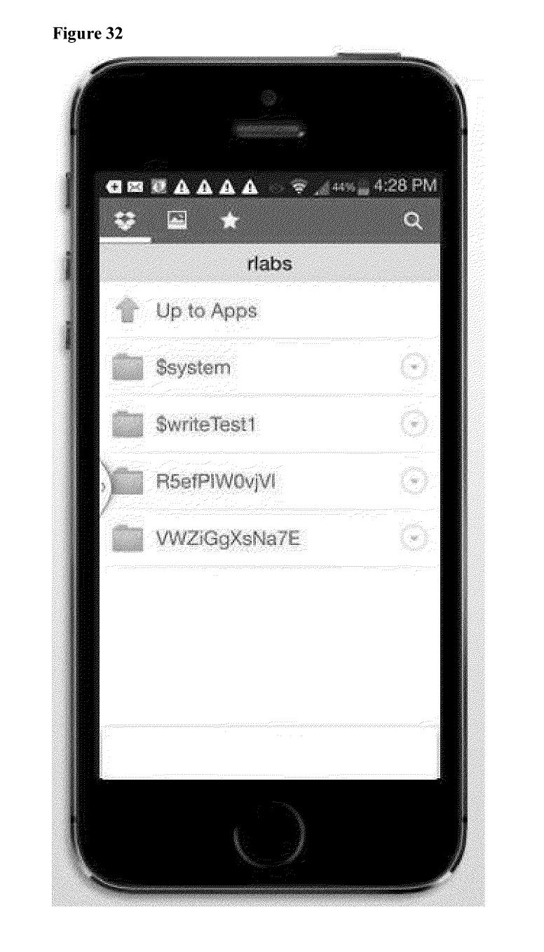

FIG. 32 shows an example screenshot of a case collection sharing GUI which may provide access to stored and/or collected data, including big data formats from authorized devices in a group. For example, the computer may be equipped with a secure, distributed storage sharing platform for collection, exchange, storage, backup, and/or analysis of data. Because the sensing etc. may be non-invasive, the use of unsafe direct server connections may be reduced. The Playbook logic itself does not use remote API calls to servers. The only direct calls to servers are between the safe runtime environment and code distribution and device authentication servers. The runtime environment can detect a change in a complex combination of device environmentals, network and server keys to prevent unauthorized exchange of data or communications.

System code may be dynamic and updateable so that it may be secured with the latest protections, for example government-level encryption and/or transmission features. The data collection container is produced by different types of Playbooks collecting and fusing data in realtime streams coming into a device independent of the multiple protocols and connection methods used to transmit the data to the device where the Playbook runs—WiFi channels, Serial adapter cable feeds, Bluetooth channels, Files synchronized using cloud storage synchronization services, etc. All of the various data channels can be fused into a data array collection format for synchronization of timestamps and location data thereby eliminating expensive map-reduce operations on a cloud data server infrastructure.

The fusion of data inside the Playbook also facilities learning normal data patterns for a complex set of variables, for example, environmental sensor data can be combined (fused) with machine data and data from operator or tenant wearable devices to provide a complete context for situational analysis and pattern detection. This data is useful for profiling normal interaction between humans, machines and the environment over time and by location. This facilitates training the system to learn normal and anomalous behaviors reducing the need for constant rule updates.

The use of the Playbook model with customization and learning of specific combinations of machinery, environment and human sensor data simplifies the personalization of the system for almost limitless scenarios. Other industrial monitoring systems rely on single sensor rule-based monitoring and alerts without proper context and scoping to a particular set of circumstances. There is a combinatorial explosion of variables that rule-based systems cannot adequately address due to many factors including unpredictable weather patterns, user behavior, specific behavior of components inside a machine produced in many parts of the world with many local suppliers with varying levels of quality and compliance with regulatory and manufacture quality standards for operating characteristics, installation quality (type of flooring affects machine operation and sensor patterns (vibration, noise, etc.)—concrete flooring has different behavior pattern than a wooden or other type of flooring, for example, All of the variability of factors increases the complexity of programming monitoring systems to detect normal or abnormal behavior leading to unsafe or costly failure conditions.

The Playbook model can be configured to easily adapt to any number of sensor channels and data feeds to create a unique data flow for monitoring the condition of equipment and facilities. This data flow signature is capture in a fusion collection container and evaluated as an array of data for statistical analysis of deviations and can also be used to automatically classify data by machine, location and usage. The traditional approach of using rule-based automation one sensor input at a time is not sufficient to handle the levels of automation required as environments become increasingly occupied by more complex forms of electronic and mechanical equipment. More equipment traditionally located only in industrial, medical, hospital and other facilities are being decentralized to homes and other facilities without adequate monitoring systems or IT support. The future use of 3D printers and other additive manufacturing and local medical lab testing will push even more complex energy-intensive equipment into homes and business locations inside large, medium and small facilities. These complex forms of equipment require additional forms of monitoring for safety and efficiency due to the high cost of failure and possible life safety impacts particularly as the global population ages requiring at-home and other forms of monitoring.

Furthermore, manufacturing and commercial activities are now becoming decentralized and dynamic into small “zones” where machinery and humans co-exist and these zones are in constant flux based on the need to produce smaller lots of products and services (mass personalization not mass production). The old centralized monitoring systems are no longer cost effective to perform these types of services due to the high cost of centralized data center computing and the cost of securing the data flows and application access.

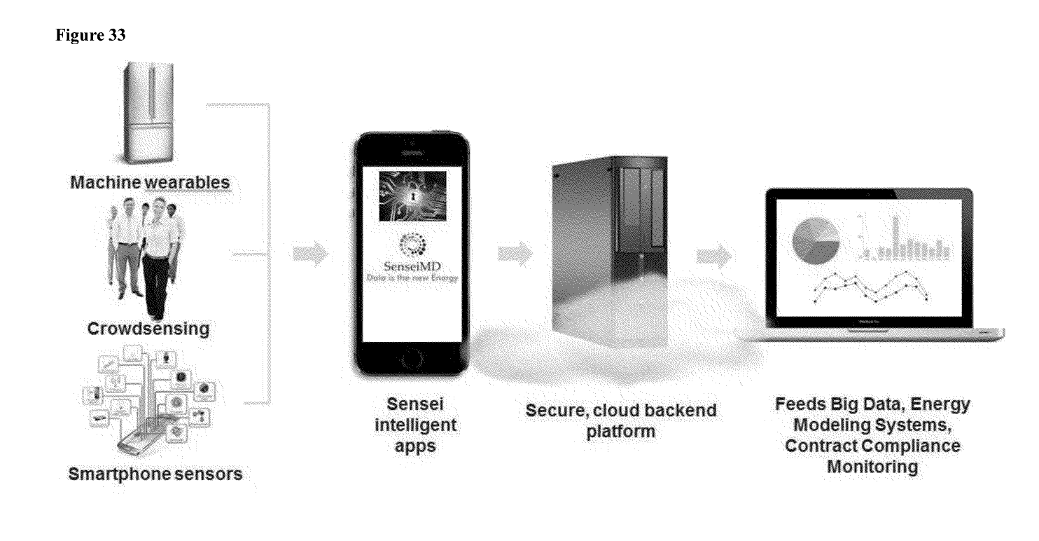

FIG. 33 shows an example architecture diagram of the system which may use short-range diagnostics and/or a secure cloud backend platform for monitoring and/or analysis. The computer may collect data via machine wearables, crowdsensing, and/or computer sensors. The data may be collected by the computer and may be sent from the computer to a backend platform (e.g., a secure cloud computer). The data sent to the backend may be used to feed big data, energy modeling systems, contract compliance monitoring, and/or other systems.

The machine data read by the smartphone operates disconnected and invisible to the existing web platforms and architectures susceptible to unauthorized access, identity and data theft. Data is asynchronously created in multiple locations and asynchronously shared with other devices on a peer-peer or group sharing basis using distributed storage, queueing and replication systems. Only data is shared not programmatic access to APIs using device credentials. Devices are further protected using a multi-factor authentication algorithm using many unique characteristics of a combination of machine identifiers, data flow characteristics, environmental factors and more. These unique keys are used to encrypt the case collection fusion data for exchange with other authorized devices. The data is further protected in a proprietary encrypted format only readable by the inventive application code.

### Additional Aspects

As disclosed herein, features consistent with the present inventions may be implemented via computer-hardware, software and/or firmware and even reconfigurable graphene computers. For example, the systems and methods disclosed herein may be embodied in various forms including, for example, a data processor, such as a computer that also includes a database, digital electronic circuitry, firmware, software, computer networks, servers, or in combinations of them. Further, while some of the disclosed implementations describe specific hardware components, systems and methods consistent with the innovations herein may be implemented with any combination of hardware, software and/or firmware. Moreover, the above-noted features and other aspects and principles of the innovations herein may be implemented in various environments. Such environments and related applications may be specially constructed for performing the various routines, processes and/or operations according to the invention or they may include a general-purpose computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various general-purpose machines may be used with programs written in accordance with teachings of the invention, or it may be more convenient to construct a specialized apparatus or system to perform the required methods and techniques.

Aspects of the method and system described herein, such as the logic, may be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects include: memory devices, microcontrollers with memory (such as 1PROM), embedded microprocessors, firmware, software, etc. Furthermore, aspects may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, and so on.

It should also be noted that the various logic and/or functions disclosed herein may be enabled using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) though do not encompass transitory media.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

Although certain presently preferred implementations of the invention have been specifically described herein, it will be apparent to those skilled in the art to which the invention pertains that variations and modifications of the various implementations shown and described herein may be made without departing from the spirit and scope of the invention. Accordingly, it is intended that the invention be limited only to the extent required by the applicable rules of law.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

1. A method of processing data, comprising:
receiving the data from a plurality of sensors of at least one mobile node or computing device (“mobile node”);
performing an analysis of the data by the mobile node; and
processing the analysis into a container.

2. The method of claim 1 further comprising:
utilizing a code route indicating at least one HTML templates to load and function a controller.

3. The method of claim 2 wherein an empty template includes a structure update inside a controller to regulate caching.

4. The method of claim 2 wherein the code route includes one or more of the following:
$routeProvider
when(‘/home’, {templateUrl: ‘inspectr/dash.html’, controller: ‘Dash’}).
when(‘/devices’, {template|Url: ‘inspectr/empty.html’, controller: ‘Devices’}).
when(‘/locations’, {templateUrl: ‘inspectr/empty.html’, controller: ‘Locations’}).
when(‘/upgrades’, {templateUrl: ‘inspectr/empty.html’, controller: ‘Upgrades’}).
when(‘/cases’, {templateUrl: ‘inspectr/empty.html’, controller: ‘Cases’}).
when(‘/diagnostr’, {templateUrl: ‘inspectr/diagFull.html’, controller: ‘Diag’}).
otherwise({redirectTo: ‘/home’});
}.

5. The method of claim 1 further comprising:
utilizing a sensor framework code to accommodate different needs.

6. The method of claim 5 wherein the sensor framework code generates new types of data comprising calculations using multiple readings simultaneously.

7. The method of claim 5 wherein the sensor framework code includes:
if (is_var(navigator.light)){
$max_light = 0;
$sparks = [ ];
$min_light = 0;
$watchLights = navigator.light.watchLight(function(light) {
// change status
$(‘#dash_light .s_status’).removeClass(‘fa-clock-
o’).addClass(‘fa-check’);
// get the reading and send it to knob
$(‘#dash_light
.s_knob’).val(light.lux).trigger(‘change’);
// check if max/min and set it
if ($max_light <= light.lux) $max_light = light.lux;
if ($min light >= light.lux) $min_light = light.lux;
//write min/max
$(‘#dash_light .s_max’).html(‘<i class=“fa
fa-caret-up”></i>
‘+$max_light);
$(‘#dash_light .s_min’).html(‘<i class=“fa
fa-caret-down”></i>
‘+$min_light);
// do graph
if ($sparks.length >= $max_values_per_array)
$sparks.shift( ); $sparks.push(light.lux);
$(‘#dash_light.spark’).sparkline($sparks, {type:
‘line’,height:’33px’,width:’70px’fillColor:’#cdf});
}, null, {frequency: $sensor frequency});
}.

8. The method of claim 1 further comprising:
loading pages from a server; and
caching the pages on the mobile node.

9. The method of claim 8 wherein the loading and the caching includes:
if (isConnected( )){
$http.get(‘http://sensei.ogg.ro/process/app/inspectr.php?devices=all’)
.success(fundion(data, status, headers, config) {
// show it
$(‘#ng-view’).html( $compile(data)($scope));
// fire it
$scope.runJS( );
// cache it
writeCache(‘page’,$location.path( )substring(l),data);
}).error(function(data, status, headers, config) {
window. plugins.toast.showShortBottom(‘Request
error!’);alert(‘error: ‘+data);});
}else if (is_var( getCache(‘page’,$location.path( )substring(l)))) {
$(‘#ng-view’).html(
$compile(getCache(‘page’,$location.path( ).substring(l)))($scope));
pageSetUp( );
$(‘#bcrumbs# bcrumb’).text(‘Devices’);
$(‘ul[id]=“deviceTab”] a[data-toggle=“tab”]’) click(function (e) {
e.preventDefault( ); $(this).tab(‘show’);
});.

10. The method of claim 1 further comprising:
receiving server readings of functionality and values before a capture process begins.

11. The method of claim 10 further comprising:
deactivating server readings once the capture process begins.

12. The method of claim 10 wherein the server readings have a frequency resolution of 1 ms.

13. The method of claim 10 wherein the reception of server readings includes:
$scope.topSensorReadings = function( ) {
$scope.watchhumidity = navigator.humidity.watchhumidity(function(h) {
if ($scope.data.avereges[‘humidity’] < h.humi)
$scope.data.avereges[‘humidity’j = h.humi;
$(‘#sensor_humidity span’).html(h.humi.toFixed(2));
}, null, {frequency: 2000});
$scope.watchLights = navigator.light.watchLight(function(light) {
if ($scope.data.avereges[‘light’] < light.lux)
$scope.data.avereges[‘light’] = light.lux;
$(‘#sensor_light span’).html(light.lux);
}, null, {frequency: 2000});
$scope.watchpressure = navigator.pressure.watchpressure(function(p) {
if ($scope.data.avereges[‘pressure’] < p.press)
$scope.data.avereges[‘pressure’j = p. press;
$(‘#sensor_pressure span’).html((p.press/1000).toFixed(2));
}, null, {frequency: 2000});
$scope.watchtempi = navigator.tempi.watchtempi(function(temp) {
if ($scope.data.avereges[‘temperature’] < temp.tempi)
$scope.data.avereges[‘temperature’] = temp.tempi;
$(‘#sensor_temp span’).html(temp.tempi ,toFixed(2));
}, null, {frequency: 2000});
}.

14. The method of claim 1 wherein code generation facilitates viewing and data display.

15. The method of claim 1 further comprising:
storing assets inside the mobile node; and
caching additional resources on request.

16. The method of claim 1 further comprising:
checking for malicious code, intrusion, and passing of unauthorized payload that can affect data.

17. The method of claim 16 wherein the checking includes:
class Security {
protected $mykey - <secret>“;
protected $_xss_hash;
protected $_never_allowed_str = array(
‘document.cookie’ => ‘[removed]’,’document.write’
=>
‘[removed]’,’.parentNode’ => ‘[removed]’,’.innerHTML’ =>
‘[removed]’,
‘window.location’ => ‘[removed]’,’-moz-binding’ =>
‘[removed]’,’<!--
=>‘&amp; lt;!--’, ‘-->“--&gt;’,
‘<![CDATA[‘ =>‘&amp; lt;![CDATA[‘,’<comment>‘ =>
‘&amp; lt;comment&gt;’);
protected $_never_allowed_regex =
array(‘javascript\s*:’,’expression\s*(\( |&\#40;)’,’vbscript\s*:’,
‘Redirect\s+302’,”([\’”])?data\s*:[\hat{ }\\1]*?base64[\hat{ }\\l]*?,[\hat{ }\\1]*?\\l?”);
protected $words = array(‘javascript’, ‘expression’, ‘vbscript’,
‘‘script’, base64’,’applet’,
‘alert’, ‘document’, ‘write’, ‘cookie’, ‘window’);
protected $naughty =
‘alert | applet | audio | basefont | base | behavior | bgsound |

blink | body | embed

| expression | form | fr ameset|f
rame | head | html | ilayer | iframe | input | isindex | layer |

link | meta | object |

plaintext | style | script | textarea |t itle|video|xml |xss’;
protected $more_evil =
‘#(alert | cmd | passthru | eval | exec | expression | system |

fopen | fsockopen |

file | file_get_contents | readfile | unlink) (\s*)\((.*?)\)#si’;.

18. The method of claim 1 further comprising:
providing encryption via RIJNDAEL_{—}256 salt and pepper encryption.

19. The method of claim 18 wherein the encryption includes:
$iv_size = mcrypt_get_iv_size(MCRYPT_RIJNDAEL_256,
MCRYPT_MODE_ECB);
//get vector size on ECB mode
$iv = mcrypt_create_iv($iv_size, MCRYPT_RAND); //Creating
the vector
$cryptedpass = mcrypt encrypt (MCRYPT RIJNDAEL 256,
$this−>mykey, $string,
MCRYPT_MODE_ECB, $iv);

20. The method of claim 1 further comprising:
initialization of a main module that controls the application and includes security methods to limit the use of remote requests only to authorized servers and loads the multi-language module that allows for instant translation of all text present inside the application at any level.

21.-46. (canceled)
